(19) United States
(12) Patent Application Publication
(10) Pub. No.: US 2016/0337727 A1
(43) Pub. Date: Nov. 17, 2016

(54) System and Method for Photonic Structure and Switch

(71) Applicant: Huawei Technologies Co., Ltd., Shenzhen (CN)

(72) Inventors: Alan Frank Graves, Kanata (CA); Dominic John Goodwill, Ottawa (CA)

(21) Appl. No.: 14/710,356

(22) Filed: May 12, 2015

(51) Int. Cl. H04Q 11/00; G02B 6/42; G02B 3/00; G02B 6/38; G02B 6/35; G02B 6/32

(52) U.S. Cl. CPC H04Q 11/0005; G02B 6/3556; G02B 6/32; G02B 3/0087; G02B 3/005; G02B 6/3897; G02B 6/4278

(57) ABSTRACT

An optical connection includes a first array of holes on a first side of a registration plate and an array of grooves on a second side of the registration plate. The optical connection also includes a first plurality of GRIN lenses inserted into the first array of holes, where the first plurality of GRIN lenses includes a first GRIN lens in a first hole of the first array of holes and a second plurality of GRIN lenses inserted in grooves of the array of grooves, where the first side of the registration plate is opposite the second side of the registration plate, where the second plurality of GRIN lenses includes a second GRIN lens in a first groove of the array of grooves opposite the first GRIN lens, and where the first GRIN lens is optically coupled to the second GRIN lens by an air gap in the first.

### TECHNICAL FIELD

The present invention relates to a system and method for photonics, and, in particular, to a system and method for a photonic structure.

### BACKGROUND

Data centers route massive quantities of data. Currently, data centers may have a throughput of 5-10 terabytes per second, which is expected to drastically increase in the future. Data centers contain huge numbers of racks of servers, racks of storage devices, and other racks often with top-of-rack (TOR) switches, all of which are interconnected via massive centralized packet switching resources. In data centers, electrical packet switches are used to route all data packets, irrespective of packet properties, in these data centers.

Photonic packet switching may be useful in data centers due to the fast speed of photonic switching. However, photonic buffers are problematic to create. Photonic switching architectures may reduce or eliminate the use of photonic buffers. To address the lack of photonic storage and buffering, photonic switches may utilize accurate timing, with the input photonic signals being accurately aligned in time at the inputs of the photonic switch by generating these signals via electronic means in switch peripherals, such as the TOR. For switched entities (e.g. packets) from different inputs to avoid collision at the output of a central switch, the differences in timing at the input (input skew) plus the set up time for a photonic switch may be shorter than the gap time between photonic packets or containers. A source of delay and skew is the optical path length light travels along the optical switch. The optical paths have a non-zero average length, which introduces an average delay, and a non-zero variation in optical path length, introducing skew. A large skew may reduce or eliminate the inter-packet or inter-container gap, leading to errors. Even if the inputs are aligned in time to remove this input skew, when the different paths through the central switch have different physical lengths, skew is reintroduced, resulting in a degradation of the inter-packet gap, leading to difficulties in discriminating packet boundaries in the destination peripheral or, for large skew, causing overlapping or clipping of switched entities corrupting the data flow. Hence delay and skew through a photonic switch are problematic.

### SUMMARY

An embodiment photonic structure includes a plurality of input stage cards including a first input stage card and a second input stage card, where the first input stage card is parallel to the second input stage card, where a first plane is at an edge of the plurality of input stage cards, and where the first plane is orthogonal to the plurality of input stage cards. The photonic structure also includes a plurality of center stage cards optically coupled to the plurality of input stage cards, where the plurality of center stage cards includes a first center stage card and a second center stage card, where the first center stage card is orthogonal to the first input stage card and the second input stage card, where the second center stage card is orthogonal to the first input stage card and the second input stage card, where the first plane is at a first edge of the plurality of center stage cards and orthogonal to the plurality of center stage cards, where a second plane is at a second edge of the plurality of center stage cards, where the second plane is parallel to the first plane, where the first center stage card is directly optically coupled to the first input stage card and the second input stage card, and where the second center stage card is directly optically coupled to the first input stage card and the second input stage card. Additionally, the photonic structure includes a plurality of output stage cards optically coupled to the plurality of center stage cards, where the plurality of output stage cards includes a first output stage card and a second output stage card, where the first output stage card is orthogonal to the first center stage card and the second center stage card, where the second output stage card is orthogonal to the first center stage card and the second center stage card, where the second plane is at an edge of the plurality of output stage cards, where the second plane is orthogonal to the plurality of output cards, where the first output stage card is directly optically coupled to the first center stage card and the second center stage card, and where the second output stage card is directly optically coupled to the first center stage card and the second center stage card. An embodiment optical connection includes a first array of holes on a first side of a registration plate and an array of grooves having a plurality of end stops on a second side of the registration plate. The optical connection also includes a first plurality of graded refractive index (GRIN) lenses inserted into the first array of holes, where the first plurality of GRIN lenses includes a first GRIN lens in a first hole of the first array of holes and a second plurality of GRIN lenses inserted in grooves of the array of grooves, where the first side of the registration plate is opposite the second side of the registration plate, where the second plurality of GRIN lenses includes a second GRIN lens in a first groove of the array of grooves opposite the first GRIN lens, and where the first GRIN lens is optically coupled to the second GRIN lens by an air gap in the first hole.

In one example, the first GRIN lens has a first diameter, where the second GRIN lens has a second diameter, and where the first diameter is smaller than the second diameter, and where the first lens is configured to propagate light to the second lens. In another example, the second plurality of GRIN lenses is configured to slide in along the array of grooves.

An embodiment registration plate includes a row of holes and a groove configured to receive a card along the row of holes, where the card includes a row of non-contact optical connectors, and where the groove is configured to align the row of non-contact optical connectors with the row of holes. The registration plate also includes an end stop at an end of the groove, where the end stop is configured to align the row of non-contact optical connectors with the row of holes.

An embodiment device includes an optical macromodule and a plurality of flexible waveguide extensions having a surface. The device also includes a plurality of graded refractive index (GRIN) lenses, where the plurality of flexible waveguide extensions are optically coupled between the optical macromodule and the plurality of GRIN lenses.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment CLOS switch;

FIG. 2 illustrates an embodiment three stage photonic switch;

FIG. 3 illustrates a rack configuration;

FIG. 4 illustrates a switching card;

FIG. 5 illustrates another switching card;

FIG. 6 illustrates a fiber shuffle;

FIG. 7 illustrates another fiber shuffle;

FIG. 8 illustrates an embodiment photonic structure;

FIG. 9 illustrates an embodiment macromodule;

FIG. 10 illustrates embodiment compliant waveguide extensions;

FIGS. 11A-B illustrate additional embodiment compliant waveguide extensions;

FIG. 12 illustrates another embodiment macromodule;

FIG. 13 illustrates another embodiment three stage photonic switch;

FIGS. 14A-C illustrate embodiment input stage, center stage, and output stage switching cards;

FIGS. 15A-B illustrate embodiment input stage switching cards;

FIGS. 16A-B illustrate embodiment output stage switching cards;

FIGS. 17A-B illustrate embodiment center stage switching cards;

FIG. 18 illustrates another embodiment macromodule;

FIG. 19 illustrates a cross sectional view of an embodiment switching card;

FIGS. 20A-B illustrate an embodiment orthogonal mapper card;

FIG. 21 illustrates an embodiment mechanical and mid-plane structure;

FIGS. 22A-N illustrate an embodiment photonic structure;

FIG. 23 illustrates a flowchart of an embodiment method of switching photonic signals in a photonic structure;

FIGS. 24A-H illustrate embodiment optical non-contact connectors;

FIG. 25 illustrates an embodiment optical non-contact connector;

FIG. 26 illustrates a graph of loss versus ratio of areas;

FIG. 27 illustrates a graph of loss versus normalized offset;

FIG. 28 illustrates an embodiment registration plate;

FIG. 29 illustrates another embodiment non-contact optical connector;

FIGS. 30A-B illustrate an embodiment retractable electrical connector;

FIGS. 31A-C illustrate embodiment grating based coupling;

FIG. 32 illustrates an embodiment combined polarization splitter and rotator; and

FIG. 33 illustrates a flowchart of an embodiment method of fabricating a photonic structure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In photonic switching, skew occurs from the difference in propagation time of light through different optical paths. For example, it is desirable for the skew to be much smaller than the inter-packet gap (IPG) between photonic packets, so the majority of the IPG may be used for photonic switch setup. Table 1 below illustrates various approaches for 100 Gb/s data streams and packet flows.

TABLE 1

| | | | Inter | | | | |
|---|---|---|---|---|---|---|---|
| | | | Packet | | % allocated | Resultant | |
| | | | (Inter- | | to switch | differential | |
| Approach to | | | contain- | | propagation | optical | |
| switching | Clock rate | | er) Gap | | skew | path length | |
| 100 Gb/s | 100 | GHz | 1 | ns | 10 | 0.8″/2 | cm |
| 120 ns long | | | | | | | |
| packet stan- | | | | | | | |
| dard IPG | | | | | | | |
| 100 Gb/s | 104-108 | GHz | 5-10 | ns | 10 | 4-8″/10-20 | cm |
| 120 ns long | | | | | | | |
| packet ac- | | | | | | | |
| celerator | | | | | | | |
| clock | | | | | | | |
| 100 Gb/s | 100 | GHz | ~17 | ns | 10 | 13″/33 | cm |
| containers | | | | | | | |
| with 2 μs | | | | | | | |
| framing | | | | | | | |

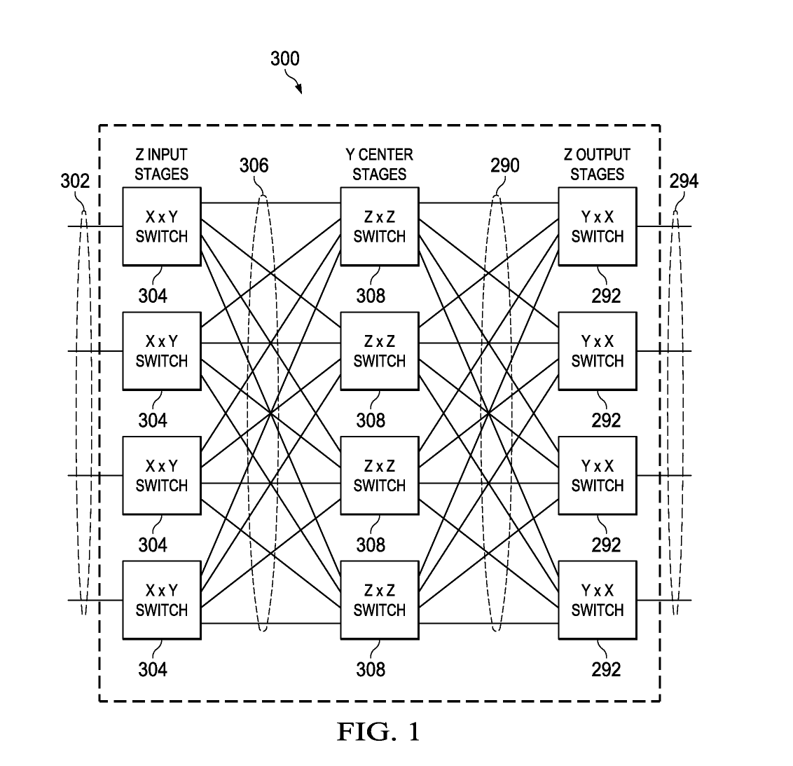

A CLOS switch configuration may be used in a photonic switching fabric. FIG. 1 illustrates an example three stage CLOS switch 300 fabricated from X×Y and Z×Z switching modules, which may be built from single or multiple modules for example 16×16, 16×32, 32×32, or other sizes of fast photonic integrated circuit switch chips. A CLOS switch may have any odd number of stages, for example three. However, control is more difficult with a larger number of stages. A CLOS switch may be fabricated with square cross-point arrays (cross-point arrays with the same number of inputs and outputs) where the overall central stage has the same number of available paths as the number inputs to the fabric. Such a switch is conditionally non-blocking, in that additional paths up to the port limits can always be added but some existing paths may be rearranged. Alternatively, the switch has excess capacity (or dilation) to reduce this effect by having rectangular first stages with more outputs than inputs, thus providing an over-capacity of core switching paths. Also, the output stages are rectangular with the same number of inputs as first stage outputs and the same number of outputs as first stage inputs. This dilation will improve the conditional non-blocking characteristics until just under 1:2 dilation X/(2X−1) when the switch becomes fully non-blocking meaning that a new path can always be added without disturbing existing paths. Because no existing paths need be disturbed there is no need for path rearrangement, which simplifies a complex control process.

For example, photonic CLOS switch 300 has a physical crosspoint set up time from about 1 ns to about 5 ns although the connection maps for the switch may be completed over a much longer period by a parallel/serial pipelined processing process. Additional details on pipelined processing are further discussed in U.S. patent application Ser. No. 14/455,034 filed on Aug. 8, 2014, and entitled “System and Method for Photonic Networks,” which this application incorporates hereby by reference.

CLOS switch 300 contains input signals 302 which are fed to first stage fabrics 304, which are X by Y switches. Junctoring pattern of connections 306 connects first stage fabrics 304 and second stage fabrics 308, which are Z by Z switches. X, Y, and Z are positive integers. Also, junctoring pattern of non-contact optical connectors 290 connect second stage fabrics 308 and third stage fabrics 292, which are Y by X switches, to connect every fabric in each stage equally to every fabric in the next stage of the switch. Making the switch dilating improves its blocking characteristics. Third stage fabrics 292 produce outputs 294 from input signals 302 which have traversed the three stages. Four first stage fabrics 304, second stage fabrics 308, and third stage fabrics 292 are pictured, but more stages (e.g. 5-stage CLOS) or fabrics per stage may be used. In an example of a 3 stage CLOS, there are the same number (Z) of first stage fabrics 304 and third stage fabrics 292, with a different number (Y) of second stage fabrics 308, where Y is equal to Z times the number of first stage outputs per stage module divided by the number of second stage inputs per stage module. As an example, a switch of 1024 input ports, built from 32×64 input stages, 32×32 center stages and 64×32 output stages has 32 input stage modules, 64 center stage modules, and 32 output stage modules. The effective input and output port count of CLOS switch 300 is equal to the number of first stage fabrics (Z) multiplied by X, for the input port count, by the number of third stage fabrics (Z) multiplied by X for the output port count. In an example, Y is equal to 2X−1, and CLOS switch 300 is at the non-blocking threshold. In another example, X is equal to Y, and CLOS switch 300 is conditionally non-blocking. In this example, existing circuits may be rearranged to clear some new paths. A non-blocking switch is a switch that connects N inputs to N outputs in any combination, irrespective of the traffic configuration on other inputs or outputs. A similar structure can be created with five stages for larger fabrics, with two first stages in series and two third stages in series.

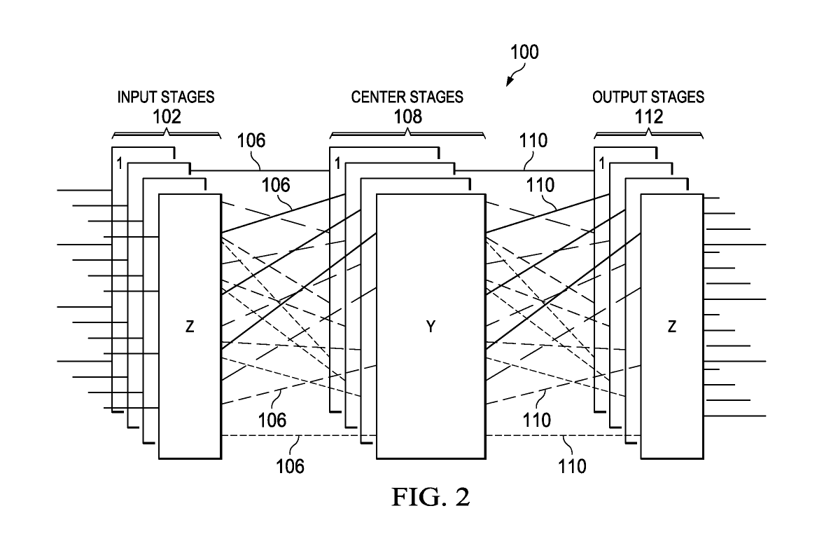

FIG. 2 illustrates the connective orthogonality of CLOS switch 100. CLOS switch 100 contains switches 102, switches 108, and switches 112. Switches 102 and switches 112 are crosspoint switches, while switches 108 may be crosspoint switches or passive arrayed waveguide routers (AWG-Rs) in which case center stage switching is achieved by changing the source wavelength. Connections 106 couple each input stage switch to each output stage switch, and connections 110 couple each center stage switch to each output stage switch. All of the center stages connect to each input stage by the same center stage input and all the center stage outputs connect to each output stage via the same center stage output. This means that, irrespective of the settings of the input stage switch and the output stage switch, any connection between a given input stage and a given output stage uses the same connectivity through whichever center stage is selected. The connectivity between stages is orthogonal, so each module of each stage may be linked to each module of every adjacent stage. Additional details on multi-stage photonic switches are further discussed in U.S. patent application Ser. No. 14/455,034 filed on Aug. 8, 2014.

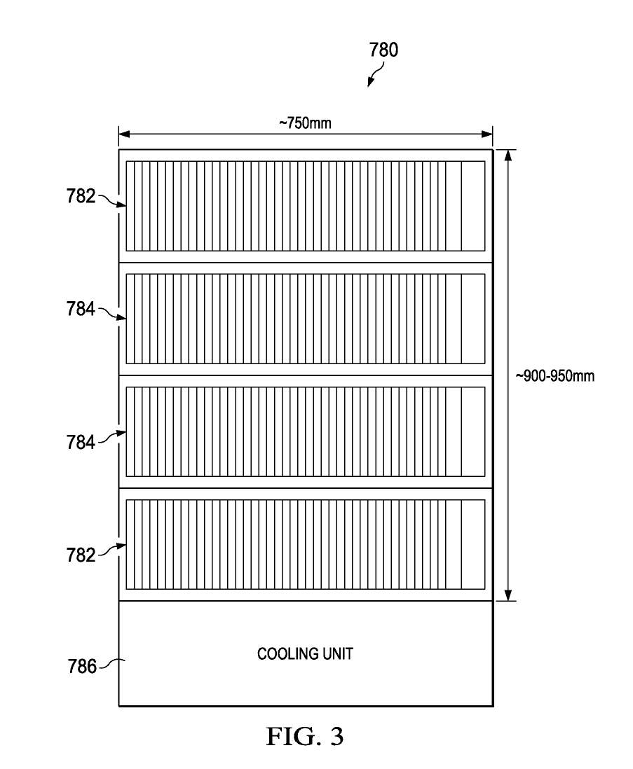

FIGS. 3-7 illustrate an implementation for a three stage photonic switch. FIG. 3 illustrates rack 780 which contains port card shelves 782 with input port/first stage switch cards, and third stage switch/output port cards and switch card shelves 784 which contain second stage switch cards. Rack 780 may implement photonic switching fabrics, such as CLOS switch 100. Rack 780 implements a four shelf 1024×1024 fast photonic circuit switch with 1:2 mid-stage dilation to create a non-blocking three stage structure based on high density circuit boards. Optical macromodules may be used on the boards to provide intra-circuit pack optical functionality and carry the InGaAsP/InP or Si crosspoint photonic integrated circuit (PIC) and associated functions, along with high density ribbon interconnect to high density multi-way optical plug-in connectors, such as Molex® connectors. The port card shelf contains 32 tributary first stage switch cards, a shelf controller, and Point of Use Power Supply (PUPS) in an about 750 mm non-standards width shelf. The switch shelf contains 32 switch cards, a shelf controller, and PUPS in an approximately 750 mm wide non-standard width shelf. Additionally, rack 780 contains cooling unit 786. Backplane interconnects may use flexi-optical backplanes. The shelf electrical backplane is a multi-layer printed circuit board with no optical interconnect. The optical interconnect is via a number of flexible Kapton® optical interconnect matrices, where individual fibers are automatically placed on a glued Kapton® film and laminated with a second Kapton® film. The interconnect to these matrices is via the Molex® multi-fiber connectors or other connectors. There is a four shelf design where two of the shelves each contain 32 input or output stage cards and the other two shelves each contain 32 switch center stage cards. The height of rack 780 may be from about 900 mm to about 950 mm. The switching cards are organized in an orderly row of vertical units and rely on the fiber shuffles to create the orthogonal connectivity.

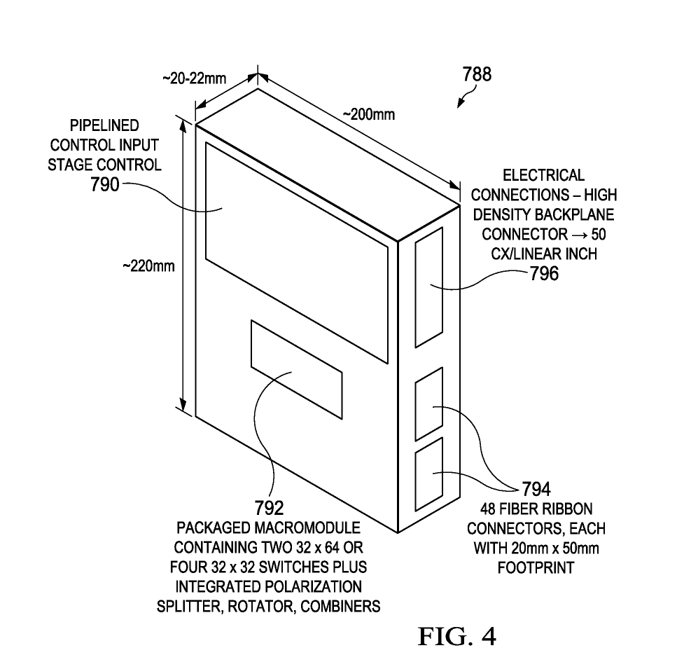

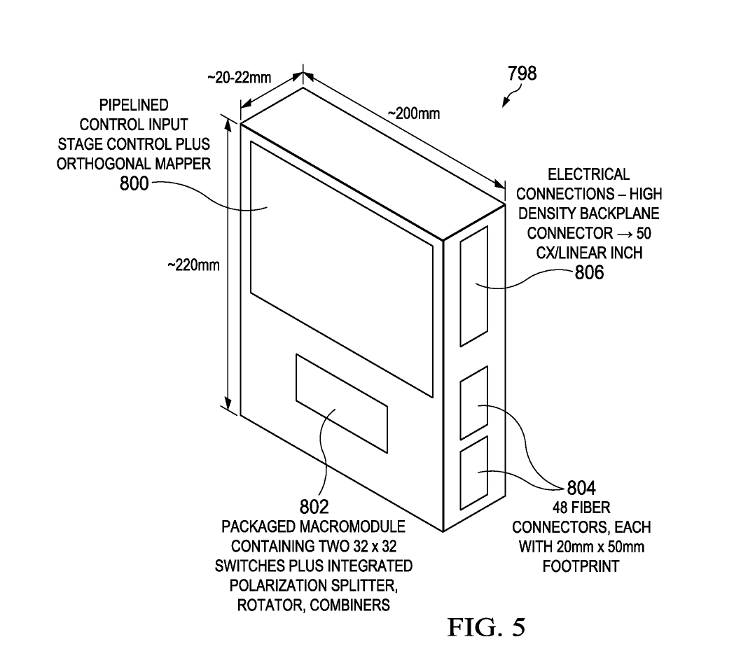

FIGS. 4 and 5 illustrate example cards for a 1024 by 1024 three stage fast photonic switching fabric. FIG. 4 shows input port card/output port card 788, which is about 200 mm by 20 mm by 220 mm. Input port card/output port card 788 includes pipelined control input stage control 790, which may implement the Source Matrix Controller (SMC) or Group Fan In Controller (GFC) functionality, depending on whether the module is a first stage module or third stage module, electrical connections high density backplane connector 796, which may have about 50 connections/linear inch, for instance as a 5 row, 0.1 inch connection pitch connector, packaged macromodule 792, and fiber ribbon connectors 794. Fiber ribbon connectors 794 contain 48 fiber ribbon connectors with a 20 mm by 50 mm footprint. Packaged macromodule 792 contains two 32×64 or four 32×32 switches, which may be fabricated from multiple smaller switches, along with integrated polarization splitters, rotators, and combiners. Macromodule design and functionality and the creation of large multi-stage switch fabrics from macromodules is described in are further discussed in Patent Application Docket Number HW 91029928US01 filed on May 12, 2015, and entitled “System and Method for Photonic Switching,” which this application incorporates hereby by reference.

FIG. 5 illustrates switch card 798, which contains pipelined control input stage orthogonal mapper 800, electrical connections 806, fiber connectors 804, and packaged macromodule 802. Electrical connections 806 include a high density backplane connector with about 50 connections/linear inch, for example with a 5 row, 0.1 inch connection pitch connector. Fiber connectors 804 contain 48 fiber connectors each, each with a 20 mm by 50 mm footprint. Packaged macromodule 802 contains two 32 by 32 switches plus integrated polarization splitters, rotators, and combiners. Input port card/output port card 788 and switch card 798 may be used in rack 780.

An input stage, center stage, or output stage card may contain a pair of crosspoint switches or a single crosspoint switch. Alternatively, the cards are more complex. In some technologies, such as electro-optic Silicon crosspoint switches, the switching performance is highly polarization dependent. The input optical signal may be split into two polarizations, one matching the crosspoint switch's best polarization plane and one orthogonal to it, which is then rotated ninety degrees before being fed into a second crosspoint switch. After switching, one of the signals is rotated ninety degrees, and the two signals are combined to create the original signal. This may be achieved in a PIC or a combination of PICs on a macromodule, which provides high throughput and may incorporate amplification to reduce stage losses, and polarization diversity for polarization-agnostic operation.

A photonic switch with four shelves, each of around 250 mm in height, may fit a one meter rack height. When switch commutation is used, two photonic switches fit in a single rack with commutator elements in a small volume in an adjacent rack. However, inter-rack cabling via an over the top overhead structure significantly adds to the delay. Commutators may be placed into a central location between the switches, adding 250 to 500 mm to the rack height, leading to a rack height of about 2.25 to about 2.5 meters. Alternatively, the commutators are distributed into the input and output stage shelves, leading to a wider shelf. Additional details on commutator based photonic switches and packaging are further discussed in U.S. patent application Ser. No. 14/508,676 filed on Oct. 7, 2014, and entitled “System and Method for Commutation in Photonic Switching,” which this application incorporates hereby by reference. When commutation is not used, a single switch occupies about 1 meter of rack height.

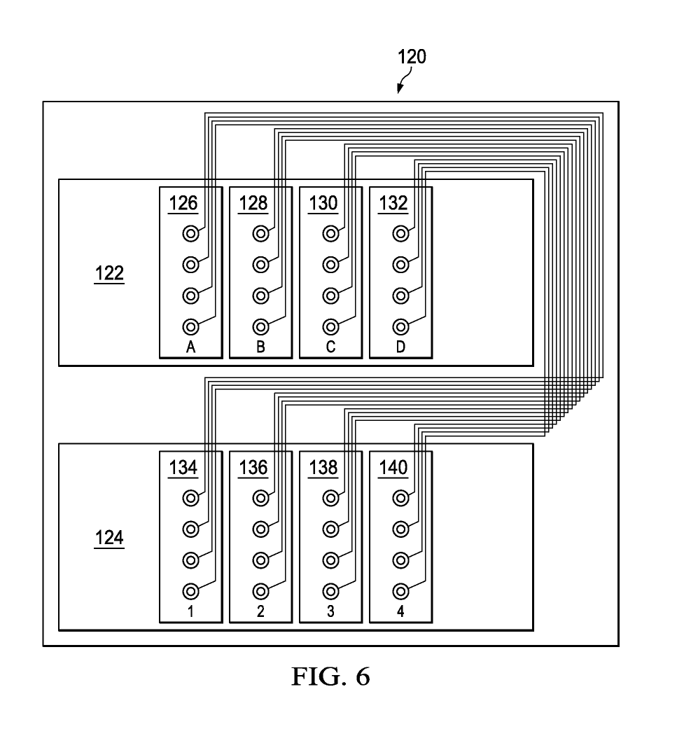

For switching stages which are orthogonally connected, and circuit packs which are not physically orthogonal, but are organized in an orderly row of vertical units, the orthogonal connections may be achieved through a fiber shuffle. FIG. 6 illustrates orthogonal connectivity between shelves 120. Each card in shelf 122 (card 126, card 128, card 130, and card 132) is connected to each card in shelf 124 (card 134, card 136, card 138, and card 140.

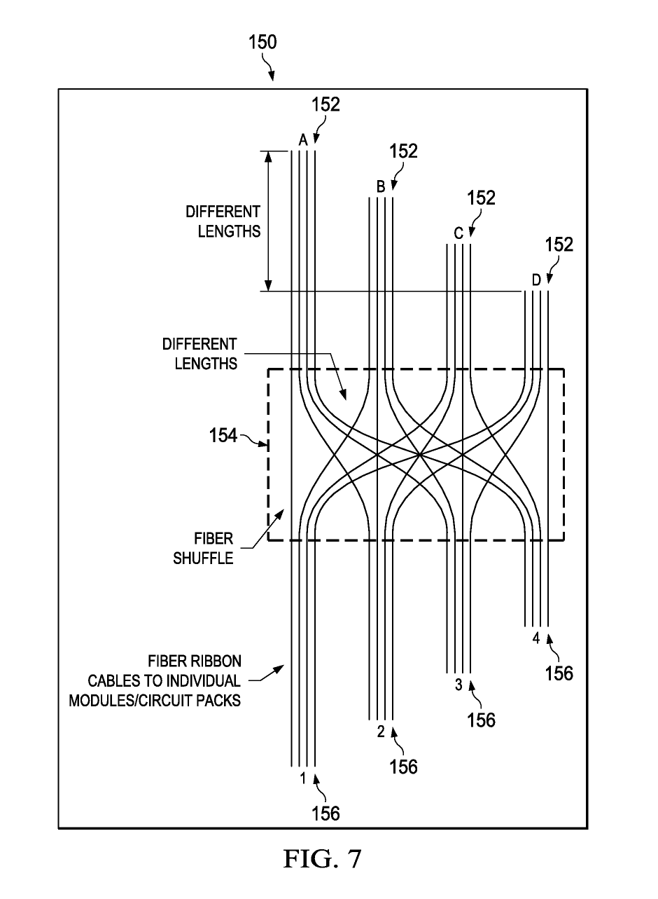

FIG. 7 illustrates fiber shuffle configuration 150. Fiber shuffle 154 connects fiber ribbon cables 152 to fiber ribbon cables 156 to achieve orthogonality. There are different optical path lengths in both the fiber shuffle and the ribbon cables, leading to skew. The fiber ribbon cables connect to individual modules and circuit packs.

In one example, optical path lengths in circuit packs and shelves are long (several meters) and the optical path lengths in the optical shuffle are very long. It is desirable for the optical path lengths to be matched to provide lower differential lengths than the limits given in Table 1, for example, within about 0.2% to about 4% of their overall length.

Table 2 illustrates a variety of sources of delay for the physical design illustrated in FIGS. 3-7. Four cm of the optical path length for the input stage switch card photonic functionality are on a PIC, with the balance for a total of 15 cm on a macromodule. The optical path length of the input stage card may be longer when individually packaged PICs and other devices on a printed circuit board (PCB) are used instead of a macromodule. The optical path length of the connections from the input stage switch card to the input stage rear optical connections are from a pigtail fiber from the macromodule to a backplane connector. Also, the optical path length of the fiber orthogonal shuffle from the input stage card to the center stage card is from the uncompensated skew from connecting to all modules which are at different distances from the fiber shuffle. This may be partially compensated for by using indirect fiber routing to nearer circuit packs. The optical delay from optical connections from the center stage optical inputs to the center stage photonic functions are from the pigtail fiber of the macromodule to the backplane connector. Additionally, the optical path length in the center stage switch card is four cm on a PIC and the balance of up to 15 cm on a macromodule. The optical path length of the center stage card may be longer when individually packaged PICs are used and other devices on a PCB. The delay from connections from center stage switch card to the center stage rear optical connects is from a pigtail fiber from a macromodule to a backplane connector, while the delay from optical connections from the output stage optical inputs to the output stage photonic functions is from a pigtail fiber of a macromodule to a backplane connector. The optical delay from the fiber orthogonal shuffle from the center stage card to the output stage card is from uncompensated skew from the orthogonal connections. Finally, the optical delay from the output stage switch card is four cm on a PIC and the balance up to 15 cm on a macromodule. The optical path length of the output stage card may be longer when it used individually packaged PICs and other devices on a PCB instead of using a macromodule. The overall average delay through the switch is of the order of 42,250 ps, which is about one third of a 120 ns frame, or 2% of a 2 microsecond frame when skew is not compensated. The uncompensated skew is almost as big as the delay, at levels of the order of 36,725 ps and this far exceeds the 100 ps-1700 ps allocated to switch propagation skew in Table 1. The uncompensated delay is primarily from the fiber shuffles connected to all their associated stage cards for orthogonal connectivity.

TABLE 2

| | Average | Average | % | Uncompensated | Compensated |
|---|---|---|---|---|---|
| | path length | Path delay | uncompensated | skew | skew |
| Delay Source | (cm) | (ps) | skew | (ps) | (ps) |
| Input stage switch card | 15 | 750 | 25 | 175 | 30 |
| Connections from input stage | 50 | 2500 | 2 | 50 | 25 |
| switch card to input stage rear | | | | | |
| optical connectors | | | | | |
| Fiber orthogonal shuffle from | 300 | 15,000 | 120 | 18,000 | 500 |
| input stage card to center stage | | | | | |
| card | | | | | |
| Optical connections from center | 50 | 2500 | 2 | 50 | 25 |
| stage optical inputs to center | | | | | |
| stage photonic functions | | | | | |
| Center stage switch card | 15 | 750 | 25 | 175 | 30 |
| Connections from center stage | 50 | 2500 | 2 | 50 | 25 |
| switch card to center stage rear | | | | | |
| optical connectors | | | | | |
| Fiber orthogonal shuffle from the | 300 | 15,000 | 120 | 18,000 | 500 |
| center stage card to the output | | | | | |
| stage card | | | | | |
| Optical connections from output | 50 | 2500 | 2 | 50 | 25 |
| stage optical inputs to output | | | | | |
| stage photonic functions | | | | | |
| Output stage switch card | 15 | 750 | 25 | 175 | 30 |
| Total | 845 | 42,250 | | 36,725 | 1190 |

Only 525 ps of the uncompensated skew is from photonic functionality, with the remainder from the packaging and inter-stage interconnections. It is desirable to reduce the uncompensated skew from the packaging and inter-stage interconnections. Designing the optical path lengths of each component to be the same optical path length, and hence have the same propagation delay, reduces the skew. However, this increases the overall delay, for example by about half of the value of the removed skew.

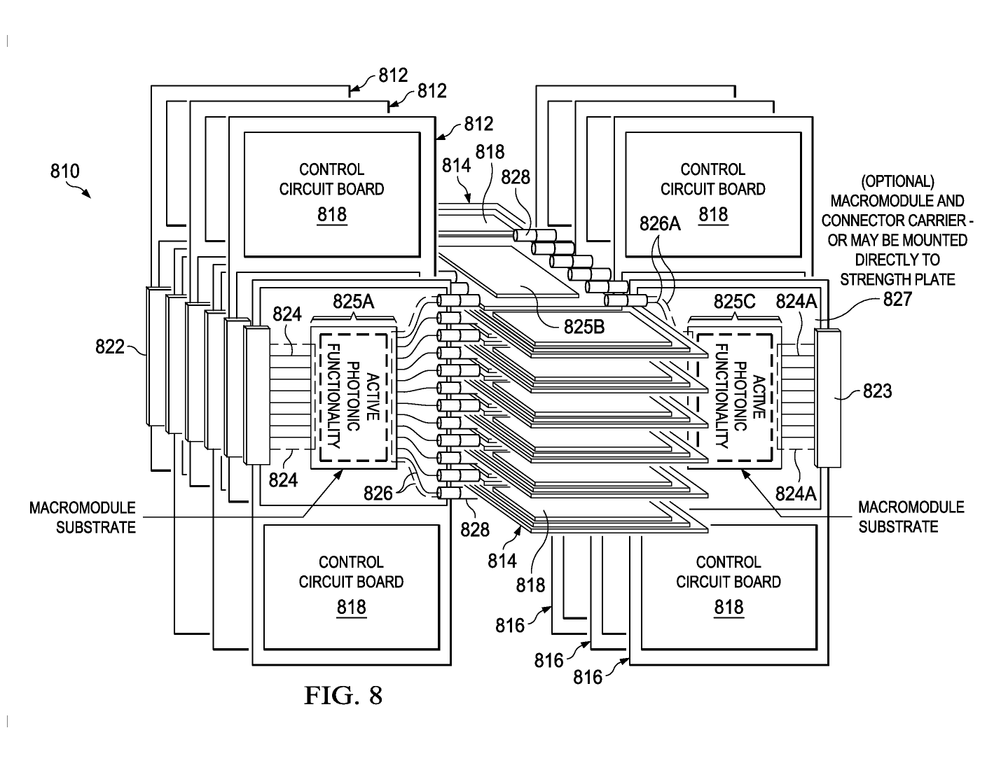

FIG. 8 illustrates photonic structure 810 which contains input stage cards 812, center stage cards 814, and output stage cards 816. The switching cards contain control circuit board 818 carried on a metal strength member 829 which contains a shell carrier of the circuit module. Also mounted on metal strength member 829 are macromodules 831, 817, or 833 depending on the switch module functionality. Macromodule 831 may include macromodule substrate 813 and active photonic functionality 815, while macromodule 833 contains macromodule substrate 819 and active photonic functionality 821. The macromodules may include optical tracking within their substrates to connect to the input connectors and output connectors directly or, as illustrated, they may connect to those connectors via extensions. When extensions are used, the macromodules and extensions may be mounted on the strength member or on an intermediate carrier which also carries the connectors.

The macromodules 831, 817, and 833 contain the active photonic functionality which may contain hybridized Si-PIC or InGaAsP/InP switch cell arrays or crosspoint switches, optical amplifiers such as semiconductor optical amplifiers (SOAs), and electronic control chips, as well as monolithically integrated dense arrays of optical interconnect, including low loss optical crossings, optical power splitters and combiners and/or polarization splitters, combiners and rotators. Instead of SOAs, when the waveguides are SiO₂, 980 nm optically pumped erbium doped waveguide amplifiers (EDWA) may be used.

Macromodule 831 is fed from the external optical inputs via a lithographically defined waveguide array 824, which may be a polymer on polymer waveguide array, from input ribbon fiber cable connector 822. The processed/switched outputs of macromodule 831 are fed via waveguide array 826 with a known geometry to a series of expanded beam non-contact connectors, such as graded index lens (GRIN) connectors 828. The exiting facet of the GRIN lens (as well as the entry facet of its mating lens) may be anti-reflection coated to avoid the air gap between the two components acting as an optically resonant cavity.

The center stage also contains a macromodule 817, which contains similar functions to those of 813 but is dimensionally and functionally customized to the role of a center stage switching stage. Macromodule 817 receives its inputs via the receive side of the GRIN connectors 828, via controlled length optical paths. After its switching/processing the macromodule outputs are coupled to the center stage output connectors, connector 835 where they are coupled into the output stage card via its input connector, connector 835, and passed through controlled length optical connection path 827 into the macromodule 833. The switched/processed output from this macromodule exits the switch via controlled length optical links 825 and output connector 823.

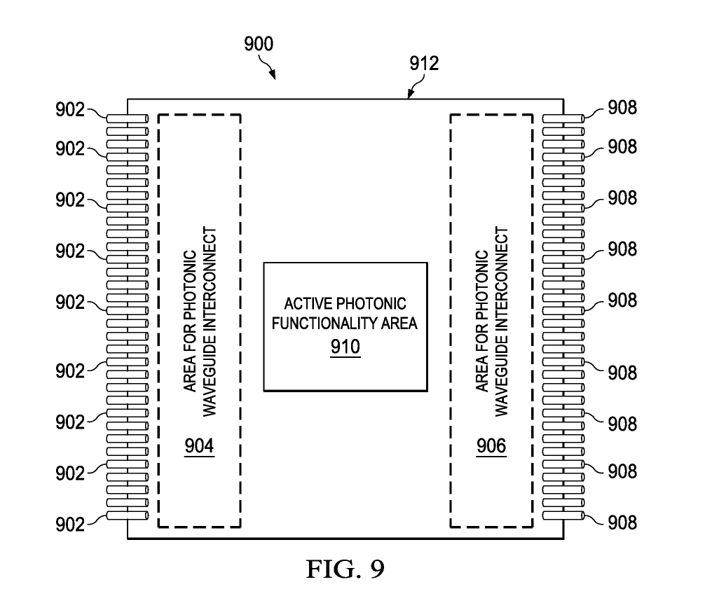

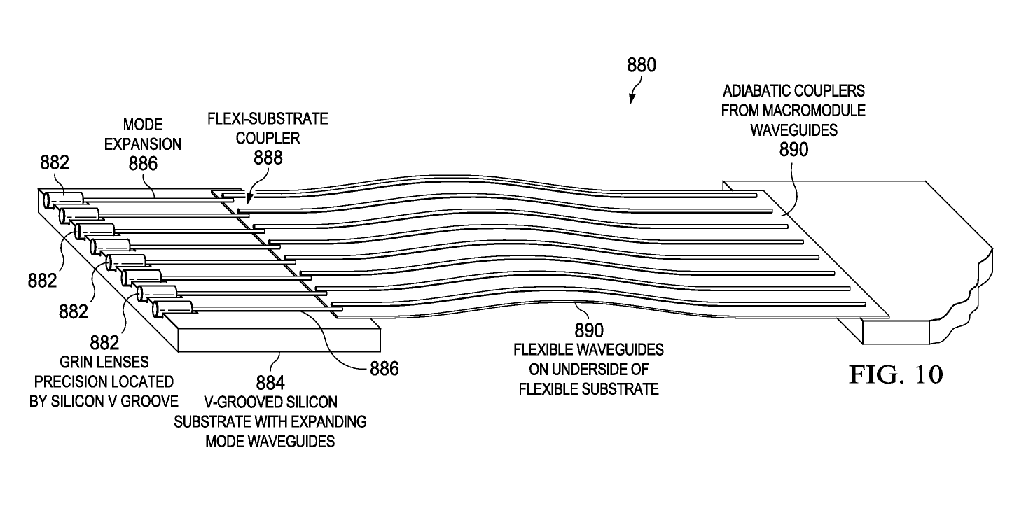

FIG. 9 illustrates large substrate macromodule 900 carrying non-contact connectors. Macromodule area 910, which contains the active photonic functionality, is integrated into macromodule substrate 912, which also contains area for photonic waveguide interconnect 904 to equalize path lengths. Area for photonic waveguide interconnect 904 is coupled to optical connector 902. Macromodule area 910 is coupled area for photonic waveguide interconnect 906, also to equalize optical path lengths, which is coupled to optical interconnect 908.

The non-contact connectors may be mounted using precision etched V-groove technology directly on the macromodule substrate. When V-grooves are directly etched on the macromodule substrate, the width of the macromodule is extended to match the apertures in the mid-planes, increasing the size of the macromodule.

In another example, the optical expanded beam connectors are mounted off the macromodule using polymer waveguide based mechanically compliant extensions, such as mechanically compliant extension with integrated waveguides 880 in FIG. 10 with an intermediate mode expander on the GRIN lens substrate and mechanical alignment block. Integrated waveguides 880 contain GRIN lenses 882, which are precision located by silicon V grooves in V-grooved silicon substrate with expanding mode waveguides 884. The expanded mode waveguides may be polymer or silica waveguides. Mode expansion 886 assists in coupling into GRIN lenses 882. In the reverse path, mode compression is used, which may be similar to mode expansion structures, with the light propagating in the reverse direction. Flexi-substrate coupler 888, which may be closely coupled waveguides, a diffraction coupler, a butt coupler, or another coupler, is used for coupling to flexible waveguides on flexible substrate 890. The flexible waveguides may be polymer or silica waveguides. Adiabatic couplers 892 are used for coupling to the macromodule.

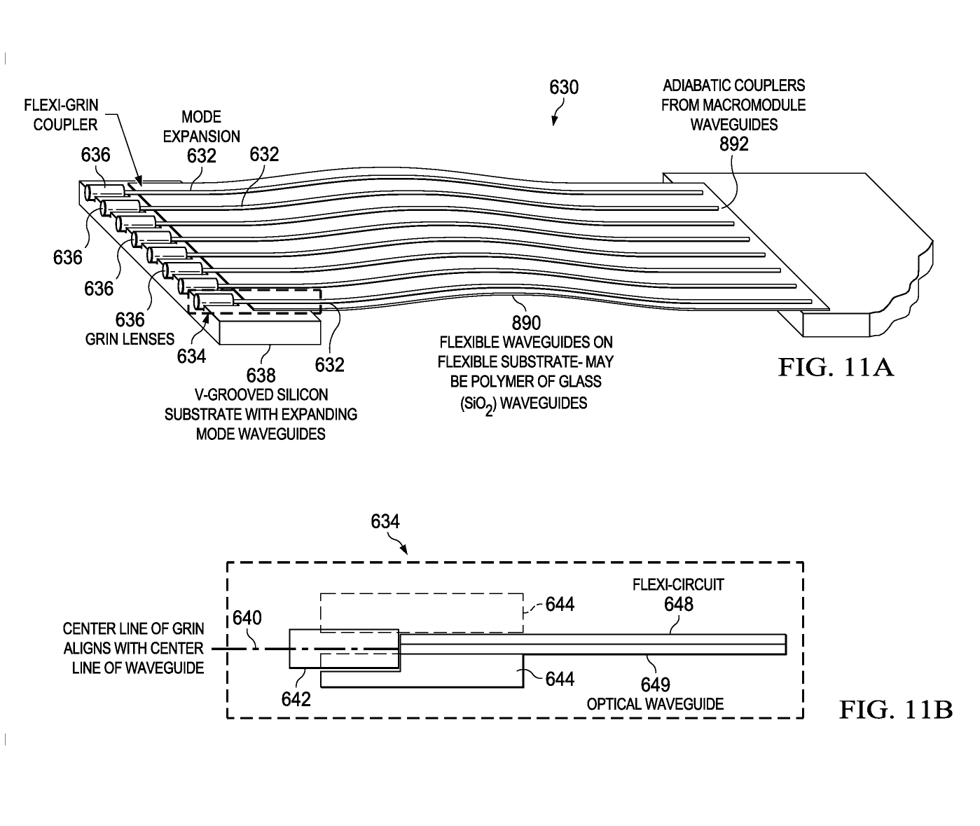

FIGS. 11A-B show an integrated waveguide where the expansion occurs in the flexible extension and the mechanical alignment block serves no optical function besides the mechanical alignment. FIG. 11A illustrates integrated waveguides 630 with GRIN lenses 636 in V-grooved silicon substrate with expanding mode waveguides 632 by flexi-GRIN coupler 638, which may be a butt coupler. Cross section 634 is illustrated in FIG. 11B. V-grooved silicon substrate 644 is an alignment aid which does not include the optical path. Light is coupled from GRIN lens 642 having center line 640 through flexi-circuit 648 containing optical waveguide 649. These extensions facilitate arbitrary routing of extension waveguides from the macromodule to the connectors, decoupling the size of the macromodule from the size of the aperture.

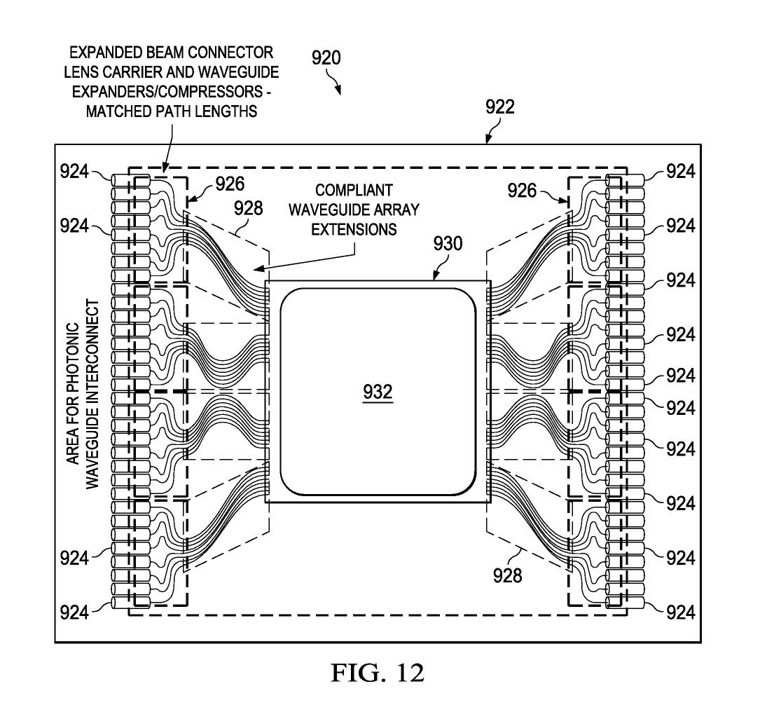

FIG. 12 illustrates macromodule 920 with compliant extensions to expanded beam connectors. Substrate area 930 contains macromodule 932, which contains the photonic interconnect, monolithic components, and hybridized components to facilitate the photonic functionality of the switch stage module. The substrate area is set by the photonic functional area, interconnect area, and coupling to compliant extensions. Compliant extensions 928 couple macromodule 932 to expanded beam connector lens carriers and waveguide expanders/compressors 926, which go to connector 924, and area for photonic waveguide interconnect 922. The path lengths of the compliant waveguide array extensions are matched, as are the path lengths of the expanded beam connector lens carriers and waveguide expanders and compressors. The substrate area 930 may be implemented as a structural substrate or may be a reserved area on the metal shell/strength plate of the overall module.

In Si PIC photonic switching matrices, each cell is controlled, both for switching state (connections on or off) and optimization (optimum on-off contrast). Control may be achieved by mounting a control application specific integrated circuit (ASIC) above the optically active layer of the Si PIC and using direct chip-to-chip connections across the interface to densely couple the two chips. The Si-PIC is mounted with its optically active surface down, so it can couple to the macromodule substrate, and the control chip is mounted to the Si PIC chip for electrical connections via the Si PIC chip. The pair is mounted over a hole in the macromodule, with the Si PIC chip optically active surface down, so the edge areas of the Si PIC chip couple optically to the macromodule and the Si PIC chip picks up electrical connections from the macromodule both for its own use and for propagation to the control chip. Besides the control ASICs on the Si PIC chips, SOAs and optionally SOA controllers have electrical connections and metallic traces. Integrated circuit (IC) tracing metal may be used for connectivity.

Due to the physically orthogonal structure between the input stages and the center stages, and between the center stages and the third stages, the optical connections are direct. The connections are made with expanded beam non-contact optical connectors which propagate a beam from one connector half to the other. The facing facets of the two connector halves are efficiently anti-reflective coated to avoid forming a small resonant cavity between the two halves. The connectors are non-contacting with an air gap, facilitating the insertion and removal of individual center stage modules. The active photonics of the switching cards is carried on optical substrates or macromodules backed with a strength member, for example nickel plated steel or duralumin, which may also carry a control electronics printed circuit board on one side.

The electronic boards may be mounted above or below the optical process area of the card. Alternately, the electronics boards are all above or all below the optical processing area. The latter approach simplifies the packaging and facilitates the electronics plugging into a conventional backplane. However, former approach using two card configurations alternately doubles the spacing between the electronics boards relative to the photonic boards, facilitating more headroom for bulky electrical components with good cooling airflow while keeping the photonic spacing minimized to accommodate smaller photonic modules and optical connector pitch. In one example, the photonic macromodule carrier area is of the order for about 28 to about 96 square inches, most of which is tracking to the connector field. The use of SOA or other optical amplifiers such as EDWA compensates for losses through the crosspoint PICs hybridized on the macromodules, as well as compensating for the losses of SiO₂ or Si waveguide structures.

In one example, optical modules have a pitch of about 3-6 mm and electronic modules have a spacing of twice the photonic spacing at about 6-12 mm. This results in the optical connectors having a pitch of 3-6 mm which leads to the following connector array sizes for the connectors between the input stage and the center stage, as shown in Table 3. For small switches, the resultant length of the connector array facilitates the integration of the connector array, the tracking to it, and the macromodule active photonic component on one substrate, as is shown in FIG. 9. However, for larger switching fabrics, the size of a monolithic macromodule encompassing the connector tracking and mounting becomes very large. In this case, as for the larger port count switches in Table 3, the monolithic macromodule substrate size is the size for carrying and interconnecting the photonic functionality and precision lithographically defined waveguide structures such as those shown in FIGS. 10A-B and 11 may be used. This results in an optical path through each stage as is shown in FIG. 12 where a macromodule 920, which contains the photonic functionality, is interconnected to connectors 924 via compliant extensions 928, coupling to waveguide expanders/compressors 926. This facilitates that the physical size of the macromodule monolithic substrate is separated from the linear width of the optical connector array, which may be much larger.

TABLE 3

| | Inter-stage | |
|---|---|---|
| | connector | |
| Switch fabric size | array size | Physical array size |
| 256 × 256 port undilated | 16 × 16 | 48-96 mm × 48-96 mm |
| 256 × 256 port dilated | 16 × 32 | 48-96 mm × 96-192 mm |
| 512 × 512 port undilated | 16 × 32 | 48-96 mm × 96-192 mm |
| 512 × 512 port dilated | 32 × 32 | 96-192 mm × 96-192 mm |
| 1024 × 1024 port undilated | 32 × 32 | 96-192 mm × 96-192 mm |
| 1024 × 1024 port dilated | 32 × 64 | 96-192 mm × 192-384 mm |

Table 4 below illustrates the propagation delay and skew for photonic structure 810. The fiber shuffle delay is eliminated, and the fiber shuffle is replaced by direct orthogonal connections between macromodules using a two part GRIN lens expanded beam free space connector. The delay between devices is from optical traces from mounted GRIN lenses for expanded beam free space connections. Of the switch cards, 4 cm of each is on a PIC with the balance on the macromodule. The macromodule may be larger to provide traces to connectors. The overall delay for the structure illustrated in FIG. 8 is on the order of about 5 meters to about 10 meters, which corresponds to a delay of from about 25 ns to about 50 ns at the speed of light in glass, for example 42 ns as in Table 2. The overall delay in the packaging system illustrated in FIG. 8 is about 60 cm to about 100 cm, for a delay of about 3.5 ns to about 5 ns. This delay determines any delay for second and third stage switch set up, as well as the delay applied to a commutation frame for the output, with commutation. An example photonic structure offers a 13:1 improvement in the overall average delay to 3.25 ns before compensating the uncompensated skew primarily from the elimination of the delays through the interconnecting fiber shuffles, which are replaced by direct circuit pack-to-circuit pack optical connections through the non-contact expanded beam connectors, the orthogonality of the shuffle connections being replaced by the physical orthogonality of the circuit packs. The uncompensated skew, at 813 ps, is reduced by a factor of 45, again largely from the removal of the orthogonal shuffle. The estimated compensated skew is of the order of 110 ps, which increases the average delay by about half the improvement in skew, to about 3.6 ns. The compensated skew is about 10.8 times better than the best compensated skew from the conventional approach and is the result of both eliminating the skew of the fiber shuffle by eliminating the fiber shuffle and due to lithographically managing and matching the path lengths inside the switch modules.

TABLE 4

| | Average | Average | % | Uncompen- | Compen- |
|---|---|---|---|---|---|
| | path | path | uncompen- | sated | sated |
| Delay | length | delay | sated | skew | skew |
| source | (cm) | (ps) | skew | (ps) | (ps) |
| Input stage | 20 | 1000 | 25 | 250 | 35 |
| switch card | | | | | |
| Center stage | 25 | 1250 | 25 | 313 | 40 |
| switch card | | | | | |
| Output stage | 20 | 1000 | 25 | 250 | 35 |
| switch card | | | | | |
| Total | 65 | 3250 | | 813 | 110 |

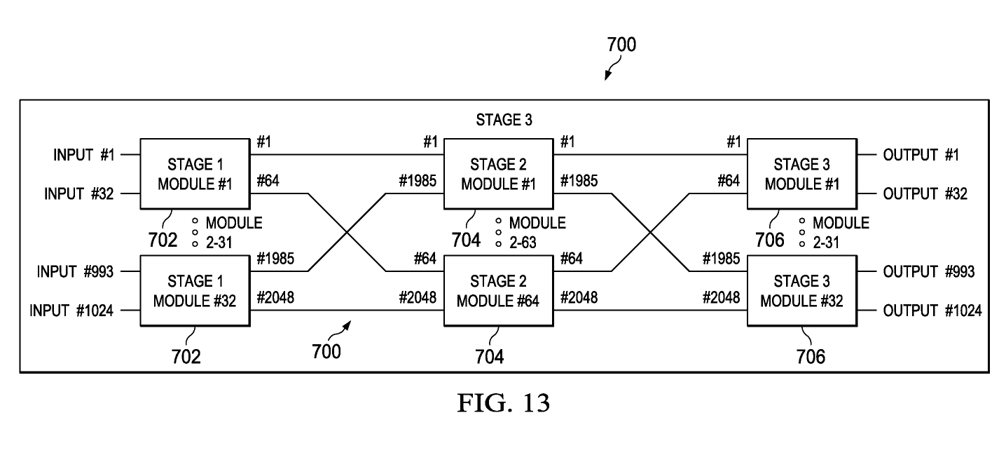

FIG. 13 illustrates the structure of a 1024×1024 three stage photonic switch with 1:2 dilation for fully non-blocking behavior. In other embodiments, a different switch size is used. System 700 contains 32 input stage modules 702, 64 center stage modules 704, and 32 output stage modules 706. Input stage module 702 contains the photonic functionality of a macromodule plus extensions, which contains polarization splitters, power splitters, 32×32 Si-PIC single polarization switch arrays, and SOAs, along with Si-PIC and SOA electronic controllers and polarization combiners. Because the incoming optical signal may be of an arbitrary polarization, and the PICs operate in a single polarization plane, the polarization splitters and combiners split the incoming signals into two polarizations, one aligned to the PIC, and one orthogonal to the PIC, which is rotated 90 degrees. After being switched by the pair of PICs this process is applied in reverse to recombine the polarization components into an optical signal with the original polarization characteristics. The optical input to the module is via a connector, such as a ribbon fiber connector, while the optical output is via an expanded beam non-contact connector, such as a GRIN-based connectors connected to the macromodule via precision optical extensions. Center stage modules 704 contain the functionality of a macromodule plus extensions, which contains polarization splitters and rotators, 32×32 single polarization Si-PICs and their controllers, SOAs and their controllers and polarization combiners. Output stage modules 706 contain the photonic functionality of a macromodule plus extensions, which contains polarization splitters and rotators, 32×32 single polarization Si-PICs, optical power combiners, arrays of SOAs and polarization rotator/combiners as well as the electronic control functions for the Si-PICs and SOAs. The photonic paths of FIG. 9 would be complemented by per switch module control electronics (the Control Circuit Board of FIG. 8) implementing the SMC, GFC or CSC (Center Stage Controller) functions as well as by a pair of orthogonal mapper cards.

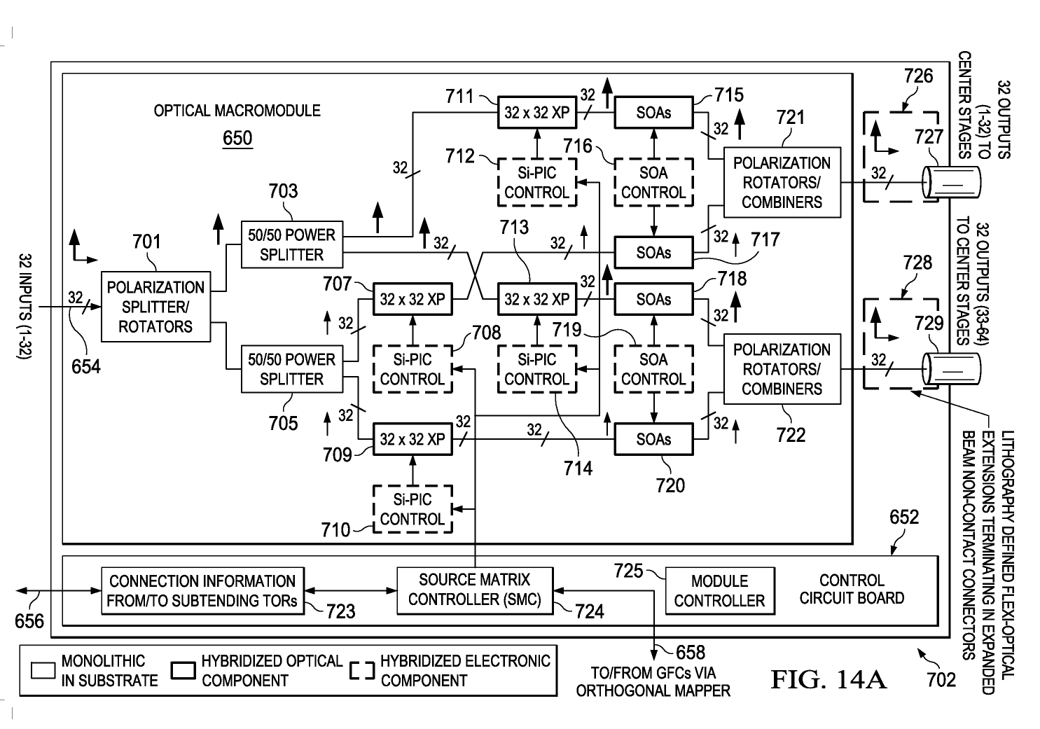

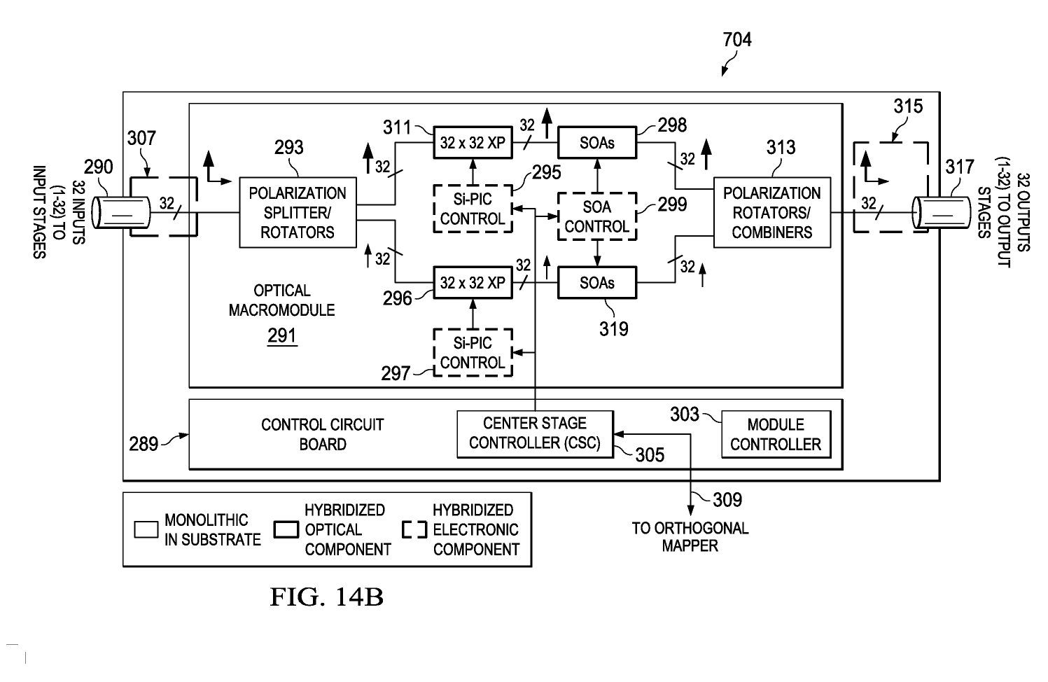

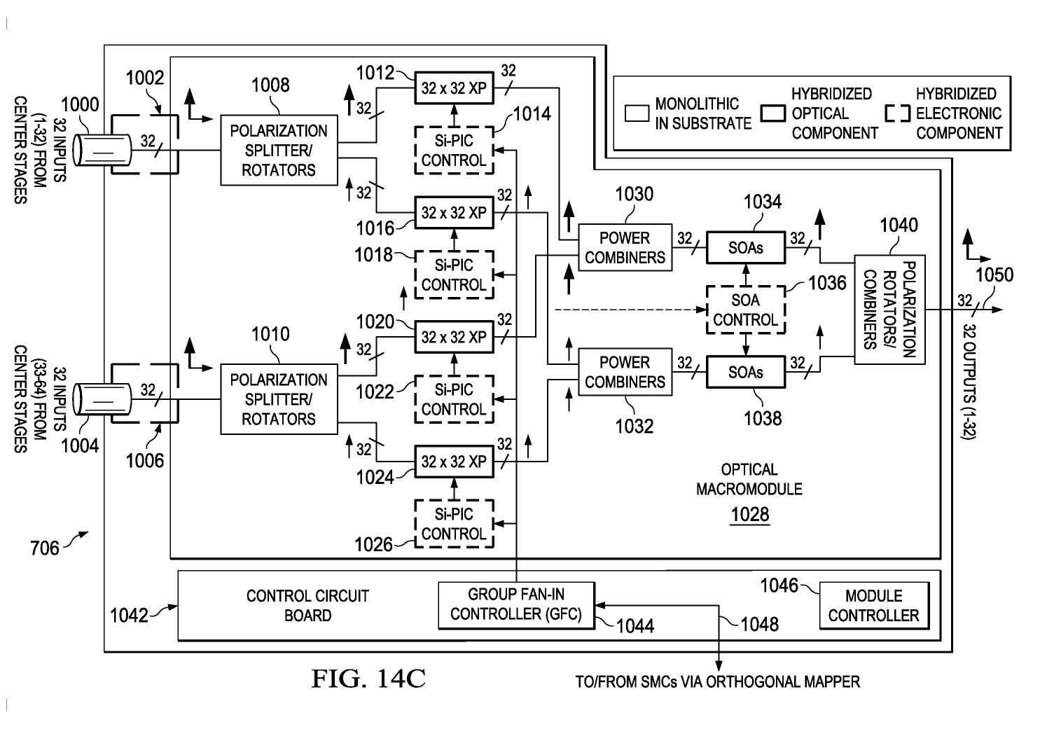

FIGS. 14A-C illustrate the functionality of input stage, center stage, and output stage cards. The overall functionality of these card modules is split between the photonic functionality of the optical connector arrays, and the electronic functionality of the control circuit board, which are combined with a high precision rigid carrier structure to create a complete switch module with both electronic and photonic functionality and with mate-able electronic and photonic connectors.

FIG. 14A shows the overall functionality of input stage module 702, which contains optical macromodule 650 and control circuit board 652. Optical macromodule 650 receives optical signals on the 32 inputs 654. The input optical signals have their polarization orthogonally split, and one split polarization is rotated by polarization splitter/rotator block 701, to produce two sets of 32 outputs having the same polarization. These streams are then each split by 50/50 power splitters 703 and 705 to yield 64 streams with two sets of 32 streams in each original polarization. These streams are switched by switches 711, 713, 707, and 709, 32/32 crosspoint photonic switches. The crosspoint switches are controlled by Si PIC controllers 712, 714, 708, and 710, respectively. The switched optical streams are amplified by SOAs 715, 717, 718, and 720, which are controlled by SOA control modules 716 and 719. The pairs of switched streams representing the two orthogonal polarizations of the input streams are then combined into two sets of combined polarization streams by polarization rotators/combiners 721 and 722. The doubling of the number of streams provide dilation for a non-blocking CLOS switch. They are output by optical extensions 726 and 728, lithographically defined flexi-optical extensions terminating in expanded beam non-contact connectors 727 and 729. Control circuit board 652 contains module controller 725, connection information from/to subtending TORs 723, which communicates with TORs through interface 656, and SMC 724, which communicates with GFCs via an orthogonal mapper with interface 658.

FIG. 14B show the overall functionality of the center stage module 704, which contains optical macromodule 291 and control circuit board 289. 32 input signals from the input stage cards are received in non-contact optical connectors 290, which propagate along optical extension 307, lithographically defined flexi-optical extensions. The optical signals are received by polarization splitter/rotator 293 in optical macromodule 291, which orthogonally splits the incoming optical inputs and rotates the polarization of one of the resultant optical signals, which are then switched by switch 311 and switch 296, 32×32 optical crosspoint switches which are controlled by Si PIC controllers 295 and 297, respectively. The outputs of the switches are amplified by SOAs 298 and 319, which are controlled by SOA controller 299. One of the amplified light streams is rotated and the two are combined by polarization rotators/combiners 313. The light streams are output by optical extensions 315 to non-contact connector 317. Control circuit board 289 contains module controller 303 and center stage controller (CSC) 305, which communicates with the orthogonal mapper with interface 309.

FIG. 14C shows the overall functionality of the output stage module 706 containing optical macromodule 1028 and control circuit board 1042. Optical inputs are received by non-contact optical connectors 1000 and 1004 from the center stage cards, and propagate along optical extensions 1002 and 1006. The optical inputs are split and rotated by polarization splitter/rotators 1008 and 1010. They are then switched by switches 1012, 1016, 1020, and 1024, 32×32 optical crosspoint switches, which are controlled by Si PIC controllers 1014, 1018, 1022, and 1026, respectively. The switched optical signals are combined by power combiners 1030 and 1032, and then amplified by SOAs 1034 and 1038, which are controlled by SOA controller 1036. The outputs are rotated and combined by polarization rotators/combiners 1040, and output by optical outputs 1050. Control circuit board 1042 contains module controller 1046 and GFC 1044, which communicates with SMCs via the orthogonal mapper at interface 1048.

The modules have a variety of elements. A module may contain a heat spreader, which may be a precision metal or thermally conductive ceramic strength plate. A large area hybridized macromodule has a substrate which supports a dense array of lithographically defined low loss optical connections, including optical crossovers and/or multiple layers of optical interconnectivity to provide the connectivity between the various hybridized photonic components and PICs as well as monolithic integrated waveguide components, such as optical power splitters and combiners, polarization splitters, rotators and combiners, and optical couplers in and out of the hybridized photonic components, such as the PICs and SOAs, as wells into couplings into waveguide extensions to optical connectors and metalized electrical connections. Thus, the substrate also supports hybridized and monolithic photonic and hybridized electronic functions and building blocks. Also, a macromodule either directly contains or connects to extensions to precision mounted expanded beam non-contact optical connectors spaced precisely along one or two opposing sides of the macromodule and coupled directly or via extensions to macromodule waveguides of other modules. The macromodule also contains a hybridized SOA and its electronic control functions or monolithic EDWA amplification capacity. EDWAs may use an on-board or may use an external high optical power pump laser at 980 nm. Additionally, the module structure plate that is carrying the photonic macromodule also carries a PCB or other form of dense electrical module for the electronic control, such as the SMC or GFC functions, or other electrical functions.

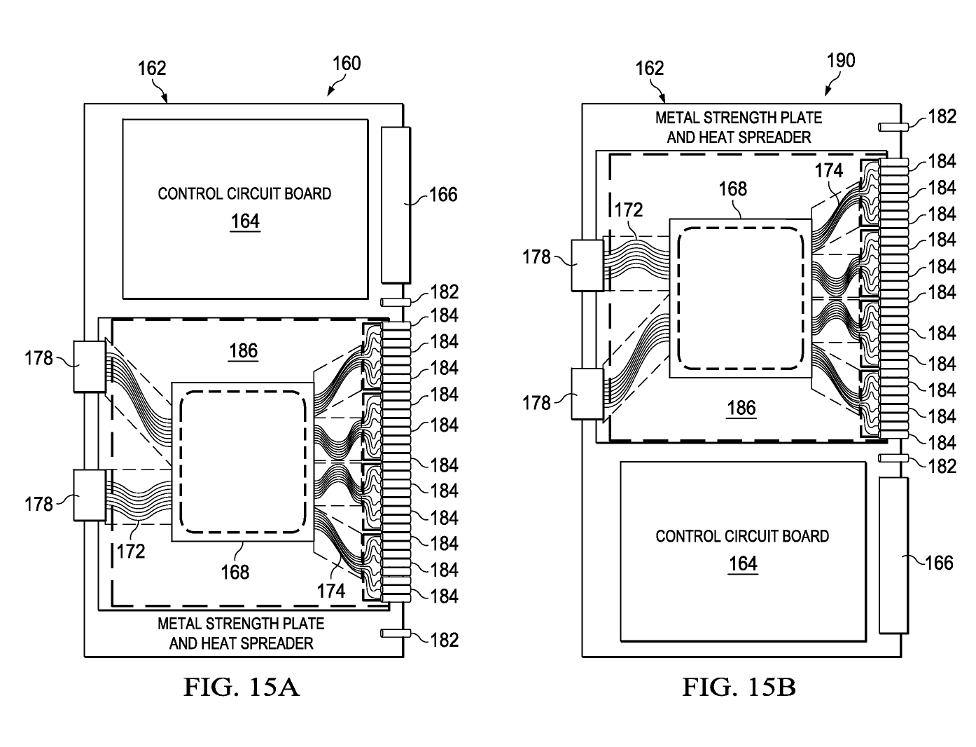

FIGS. 15A-B illustrate two examples of input stage cards, input stage card 160 and input stage card 190. Input stage card 160 and input stage card 190 have their electronic circuit boards in alternate positions to provide double the headroom for the electronics compared to the photonics when they are alternated in shelf card slots. In one half of the cards, the electronics module is above the photonics, and in the other the electronics module is below the photonics. When these two card types are inserted alternately into the slots of a card cage, they produce a 2:1 difference between the electronic and photonic component pitch, facilitating a tight photonic spacing to reduce the photonic connector field physical size, and hence the photonic macromodule physical size, with sufficient headroom in the electronics for somewhat taller components, heat sinks, and cooling air flow. The input stage card contains macromodule 168 and control circuit board 164 on metal strength plate and heat spreader 162. In another example, the strength plate and/or the heat spreader is made of another material, such as a ceramic material. Photonic path mounting plate and heat spreader 186, which is optional, has non-contact optical connectors 184 with connections to center stage cards and electrical connectors 182 with connections to orthogonal mapper cards. Alternatively these may be mounted directly to the heat spreader 162.

The photonic functionality is contained in macromodule 168, which contains the functionality shown in FIG. 14A and contains two or four single polarization matrices, for example two or four 32×32 Si-PICs, up to 64-128 SOAs in an arrays, plus polarization splitters, rotators, and combiners. Macromodule 168 is coupled to optical connectors 178 via extensions 172. The paths from the inputs to the macromodules are matched in length to preserve clock alignment. Per unit phase measurement and correction may be included in the macromodule. Alternatively, phase measurement and connection are provided externally. Macromodule 168 is also coupled to non-contact optical connectors 184 via matched length optical flexible links 174, such as lithographically defined polymer-on-polymer links.

Control circuit board 164 performs electronics functions, such as SMC functions, associated with the input stage switch. Control circuit board 164 contains a card, PCB, or module which provides electronics control to the switch and communicates with the per-Si PIC overlay electronic chips, which provide per-switch cell control and optimization. The controller circuit board also implements the SMC function for the input ports connected to its associated input stage switch card. Electronic connectors 166 couple control circuit board 164 to other cards.

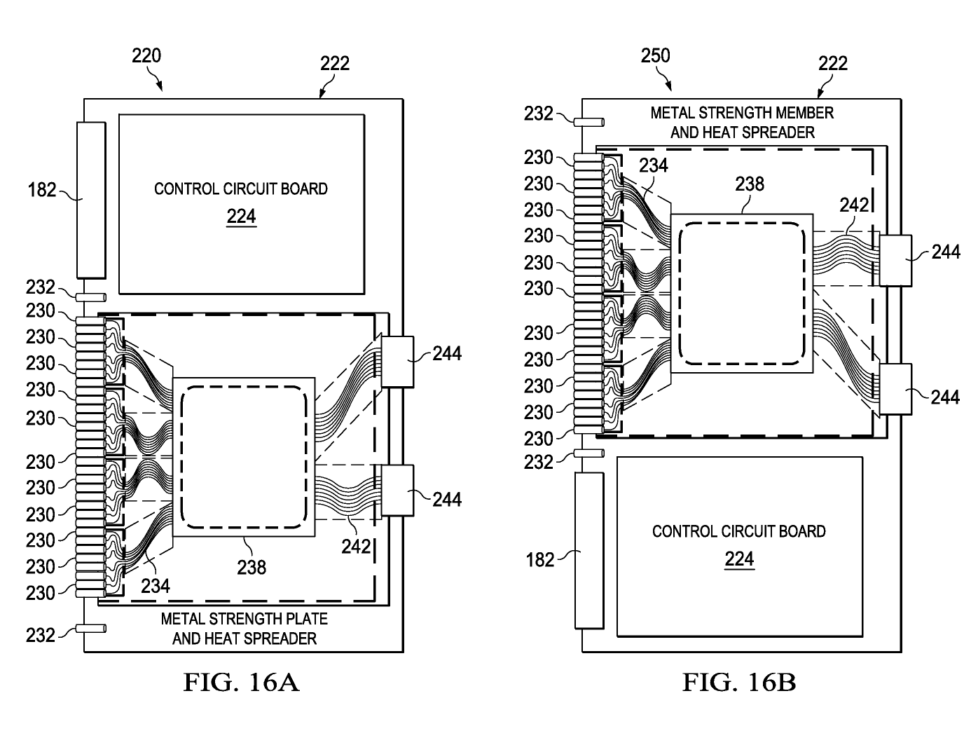

FIGS. 16A-B illustrate example output stage cards, output stage card 220 and output stage card 250. Output stage card 220 and output stage card 250 alternate to provide double the headroom for the electronics to the headroom of the photonics. In one card, the electronics module is above the photonics, and in the other the electronics module is below the photonics. When these two card types are inserted alternately into the slots of a card cage, they produce a 2:1 difference between the electronic and photonic component pitch, facilitating a tight photonic spacing to reduce the photonic connector field physical size, and hence the photonic macromodule physical size, with sufficient headroom in the electronics for relatively tall components, heat sinks, and cooling air flow. The output stage card contains macromodule 238 and control circuit board 224 on metal strength plate and heat spreader 222. In another example, the strength plate and heat spreader is made of another material, such as a ceramic material. Metal strength plate and heat spreader 222 may carry non-contact optical connectors 230.

The photonic functionality is contained in macromodule 238, which contains the functionality of FIG. 14C and contains two or four matrices, for example two or four 32×32 Si-PICs, up to 64-128 SOAs, plus polarization splitters, rotators, and combiners. Macromodule 238 is coupled to optical connectors 244 via optical waveguides 242. The paths from the inputs to the macromodules are matched to preserve timing alignment. Non-contact optical connectors 230 are used to connect macromodule 238 to each center stage card via optical extensions 234, and non-contact optical connectors 232 are used to connect control circuit board 224 to the orthogonal mapper cards. The controller card has a high speed bidirectional optical connection to an outgoing orthogonal mapper card and an incoming orthogonal mapper card. Electrical connectors 182 couple control circuit board 224 to other cards.

Control circuit board 224 performs electronics functions, such as GFC functions, associated with the output stage switch. Control circuit board 224 contains a card, PCB, or module which provides electronics control to the switch and communicates with the per-Si-PIC overlay electronic chips, which provide per-switch cell control and optimization. The controller card also implements the GFC function for the input ports connected to its associated input stage switch card.

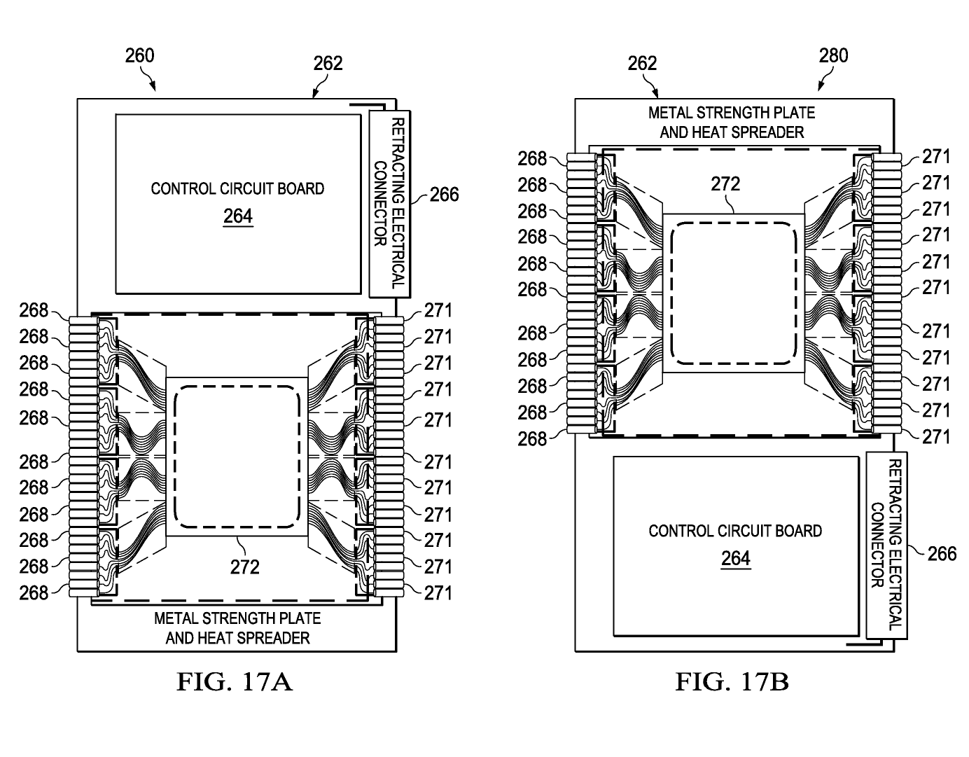

FIGS. 17A-B illustrate examples of center stage cards, center stage card 260 and center stage card 280. Center stage card 260 and center stage card 280 alternate to provide double the headroom for the electronics to the headroom of the photonics. In one card, the electronics module is above the photonics, and in the other the electronics module is below the photonics. When these two card types are inserted alternately into the slots of a card cage, they produce a 2:1 difference between the electronic and photonic component pitch, facilitating a tight photonic spacing to reduce the photonic connector field physical size, and hence the photonic macromodule physical size, with sufficient headroom in the electronics for somewhat taller components, heat sinks, and cooling air flow. The center stage card contains macromodule 272 and control circuit board 264 on metal strength plate and heat spreader 262. In another example, the strength plate and heat spreader is made of another material, such as a ceramic material.

The photonic functionality is contained in macromodule 272, which contains two single polarization crosspoint switches, for example two 32×32 Si-PICs, or an AWG-R, such as a 32×32 AWG-R, or an 80×80 AWG-R, up to 64 SOAs with 32×32 Si-PICs or up to 160 SOAs in multi-SOA arrays with an AWG-R of 80×80 ports, plus polarization splitters, rotators, and combiners. Although the AWG-R is polarization-agnostic, the SOAs exhibit polarization-dependent properties, and may be used as pairs between polarization splitters, rotators and combiners. Macromodule 272 is coupled via optical flexible precision length extensions, which may be used to equalize path lengths. Optical connectors 268 and 271 are optical non-contact expanded beam connectors used to directly optically couple the center stage card to each input stage card and each output stage card.

Control circuit board 264 performs electronics functions, such as fabric control functions, for the center stage switch, and may implement the center stage controller (CSC) function, which collects connection data from the SMC and GFC once they have finished their negotiations, to build a center stage connection map if an AWG-R is not used. Control circuit board 264 contains a card, PCB, or module which provides electronics control to the switch and communicates with the per-Si PIC overlay electronic chips, which provide per-switch cell control and optimization. The controller card is coupled to retracting electrical connector 266, a two part connector (the other part being on the mating mid-plane) which facilitates slide-in insertion of the circuit module across the face of the connector.

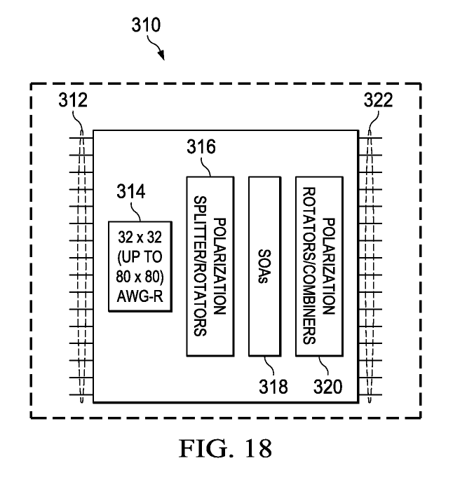

Macromodule 272 may contain crosspoint switches, like the macromodule shown in FIG. 14B, or AWG-Rs, like macromodule 310 illustrated by FIG. 18. Macromodule 310 contains optical inputs 312, 32 optical inputs which may have a loss of from about 1.5 dB to about 2.5 dB. Polarizations splitter/rotators 316 and 320 have combined losses of about 2 dB to about 4 dB. Switch 314 is an AWG-R wavelength based passive optical router. Switch 314 may be 32×32, 64×64, 80×80, or another size. Switch 314 may have a loss of about 2.5 dB to about 5 dB, depending on the number of wavelengths. Two SOAs are used between the polarization splitters and combiners to amplify each AWG-R port due to the polarization sensitivity of SOAs 318. Also, optical outputs 322, 32 optical outputs, may have losses of about 1.5 dB to about 2.5 dB.

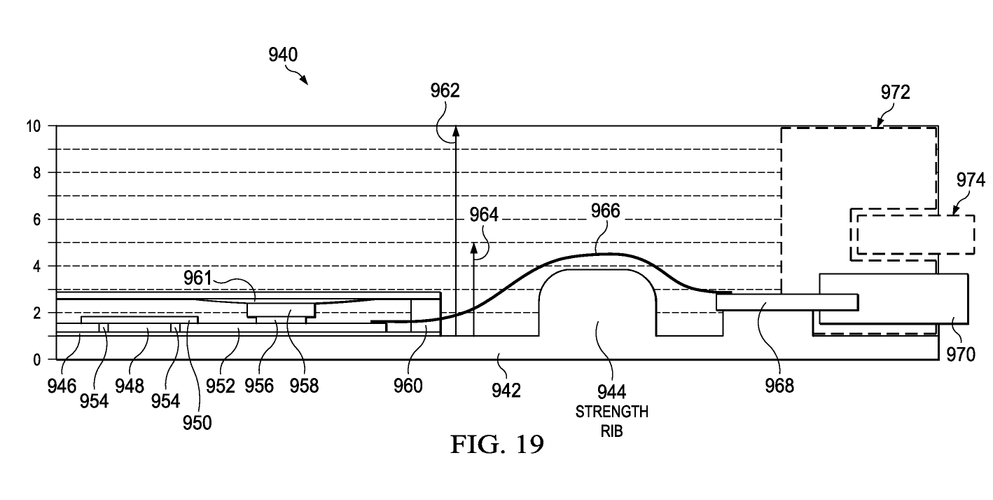

FIG. 19 illustrates a cross sectional view of part of switching card 940, which may be an input stage card, output stage card, or center stage card. The vertical dimension shows the approximate component height in mm, while the horizontal dimension is not in scale. Strength plate 942 contains strength rib 944 for additional strength. Electrical insulating layer 946, which may be silica, alumina, Kapton®, or another high quality dimensionally stable insulator, is on strength plate 942. On electrical insulating layer 946 are macromodule 952, and spacers 954. Si PIC 950 is above Si PIC controller 948. The Si-PIC controller is bonded to and connected to the Si-PIC, and receives its electrical connections and power from the macromodule 952 via the Si-PIC that it controls. The Si-PIC controller is mounted in a cavity through the macromodule 952 and may be thermally contact cooled via the electrical insulating layer 946 into the strength plate 942. SOA array 956 is above macromodule 952 and below thermo-electric cooling (TEC) 958. Also, TEC 958 is coupled to TEC heat spreader 961 for heat distribution. Cap 960 provides protection for the macromodule layer. Compliant waveguide array extensions 966 couple macromodule 952 to compliantly mounted mode expander and lens mount 968. GRIN lens 970, a 2 mm lens, is mounted on compliantly mounted mode expander and lens mount 968. Photonics headroom 964 is about 5 mm. Control circuit board 972 is above compliantly mounted mode expander and lens mount 968 and GRIN lens 970. Electronics connector 974 is coupled to control circuit board 972. In this example, the electronics headroom 962 is about 10 mm, about double the photonics headroom.

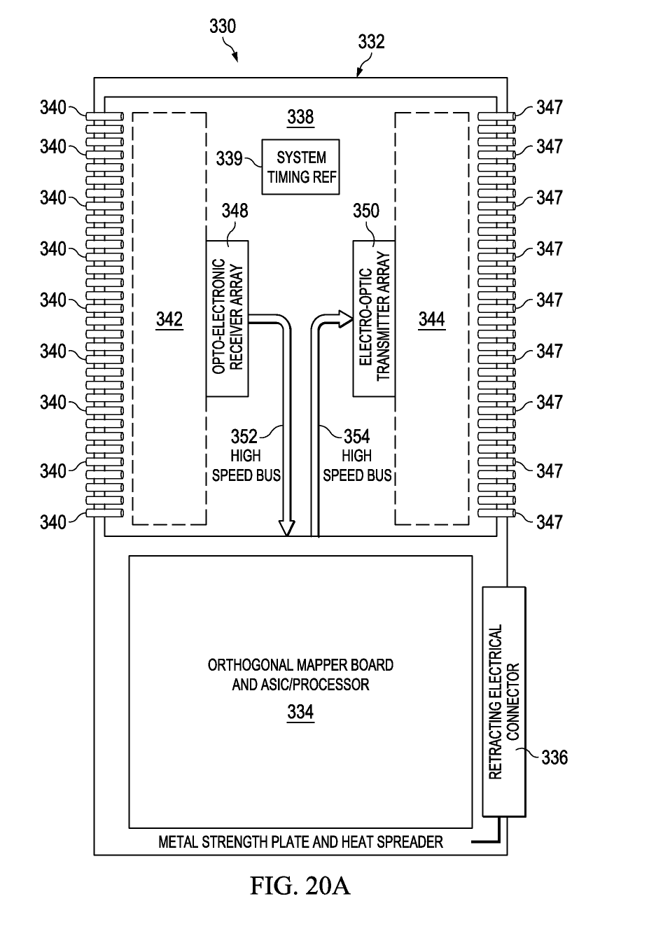

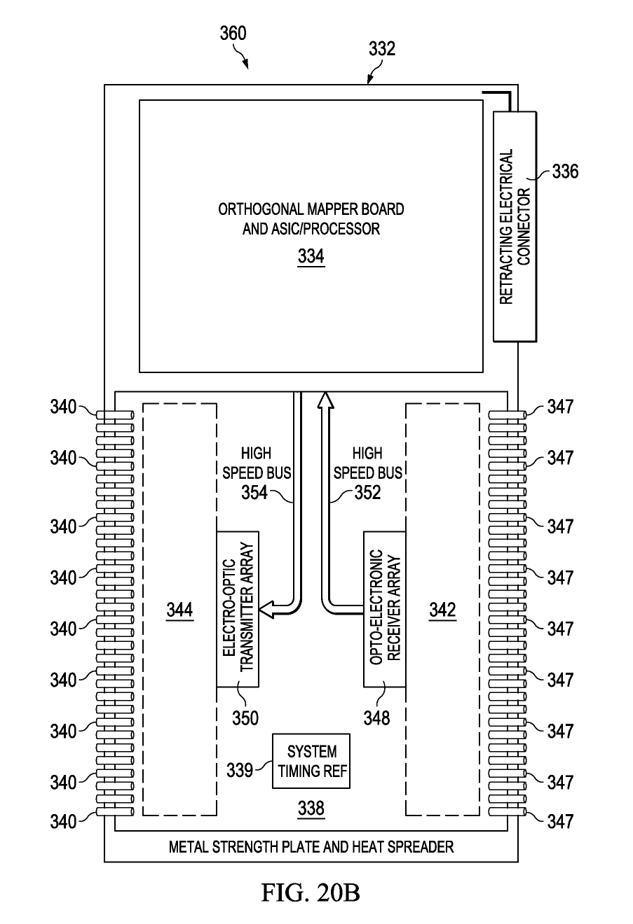

FIGS. 20A-B illustrate orthogonal mapper cards 330 and 360, two examples of orthogonal mapper cards. The orthogonal mapper card contains substrate 338 with optical devices and orthogonal mapper board 334 on metal strength plate and heat spreader 332. In another example, the strength plate and heat spreader is made of another material, such as a ceramic material.

Substrate 338 carries electro-optic transmitter array 350, which is configured to convert electrical signals received via high speed bus 354 from orthogonal mapper board 334. Also, opto-electric receiver array 348 is configured to convert optical signals to electrical signals and transmit them along high speed bus 352 to orthogonal mapper board 334. Electro-optic transmitter array 350 is coupled to area 344 for silica optical interconnect on silica or silicon. Alternatively, the non-contact optical connectors 340 and 347 may be coupled to the opto-electric receiver array 348 and electro-optic transmitter array 350 via flexible optical connection arrays as per the photonic switching cards. Area 344 is coupled to non-contact optical connectors 347, optical non-contact expanded beam connectors. Additionally, opto-electric receiver array 348 is coupled to area 342 with optical interconnect, which is coupled to non-contact optical connectors 340, optical non-contact expanded beam connectors. The optical interconnect areas equalize the path lengths. The optical non-contact connectors directly couple the orthogonal mapper card to each input stage card and each output stage card. Orthogonal mapper cards 330 and 360 communicate with the SMCs of the input stage switching cards and the GFCs of the output stage switching cards. System timing reference 339 generates system clock timing for the overall switch and the dependent TOR-located functions, such as packet splitters and combiners.

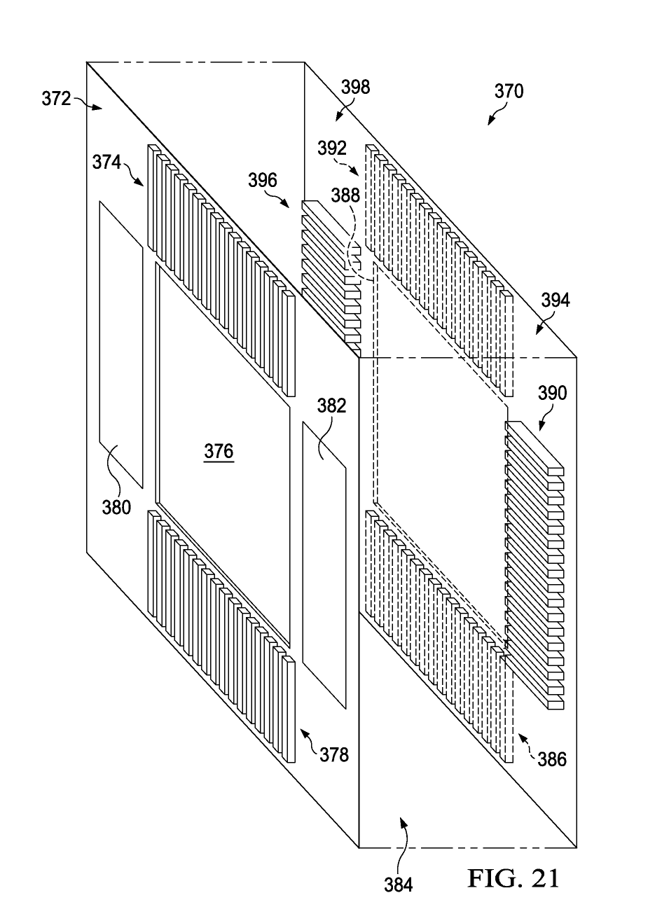

Orthogonal mapper board 334 performs orthogonal mapper routing functions. Orthogonal mapper board 334 may contain a processor and/or application specific integrated circuit (ASIC). The orthogonal mapper board is coupled to refracting electrical connector 336, a slide-in connector. The operation of the orthogonal mapper is described in U.S. patent application Ser. No. 14/455,034. FIG. 21 illustrates mid-plane structure 370, a mechanical structure for a photonic switching structure. Card cages, alignment details, and card guides are present but not pictured. Also, a metallic mechanical support structure and thermal management (air flow) structure is not pictured. The metallic structure carries two parallel precession located PCB mid-plane structures, mid-plane 372 and mid-plane 394. Mid-plane 372 carries conventional electrical connectors for input stage cards, while mid-plane 394 has conventional electrical connectors for output stage cards and retractable connectors for center stage cards.

Mid-plane 372 has aperture 376, and mid-plane 394 has aperture 388, which are in the center of the mid-planes. Aperture 376 is for non-contact expanded beam optical connectors for communications between the input stage switch cards and the center stage switching cards and orthogonal mapper cards. Similarly, aperture 388 is for non-contact expanded beam optical connectors to communicate from center stage switching cards and orthogonal mapper cards to output stage switching cards. Both mid-plane apertures contain a registration plate not shown in FIG. 21 for optical alignment between the two halves of each non-contact expanded beam optical connector, one half of which is plug-in and one half of which is slide in.

Electrical connectors 378 and 374 are on mid-plane 372, while electrical connectors 392 and 386 are on mid-plane 394. Electrical connectors 378, 374, 392, and 386 are vertically mounted multi-pin electrical connectors. Non-contact optical connectors 184 of the input stage cards may protrude through aperture 376, and non-contact optical connectors 230 of the output stage cards may protrude through aperture 388 to within a fraction of a millimeter or a millimeter or two of the slid in non-contact optical connectors 340 and 347 of the center stage cards.

Electrical connectors 396 and 390 on mid-plane 394 are horizontally mounted connectors on the inner surface of mid-plane 394. Electrical connectors 396 and 390 are for slide-in insertion connections, so the center stage insert-able module is slid in to the slot horizontally across the face of the two vertical mid-planes. The connector contacts on the plug-in module may be retractable to facilitate this slide-action insertion, for example with a cam action activated by rotating a connector release lever.

Apertures 380 and 382 on mid-plane 372 facilitate input stage air plenum airflow in the center area and to cool the center stage cards.

Mid-plane interconnect 384 and 398 is a mid-plane interconnect PCB or flexi-circuit between mid-plane 372 and mid-plane 394.

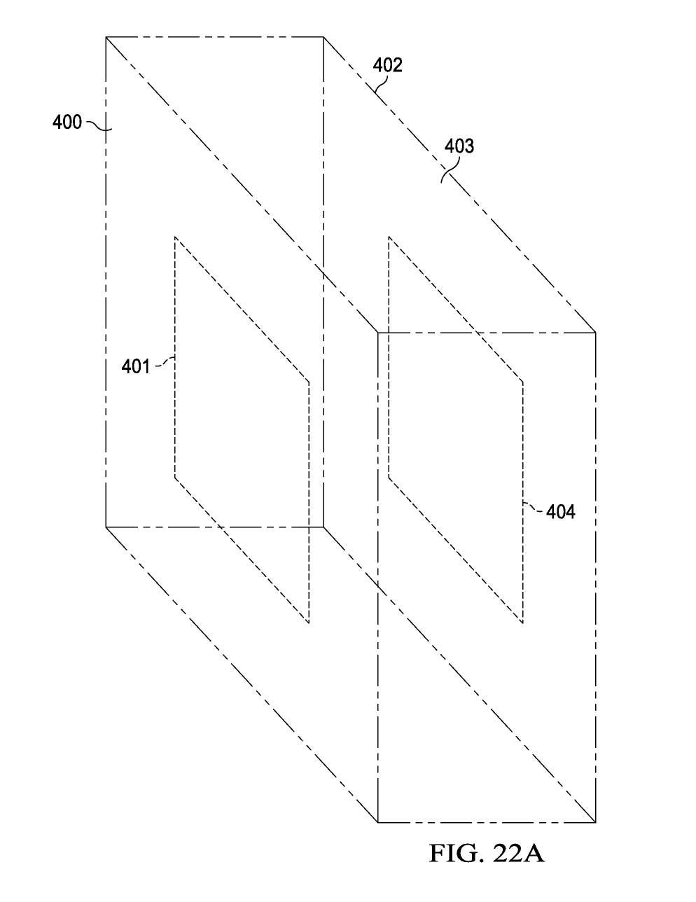

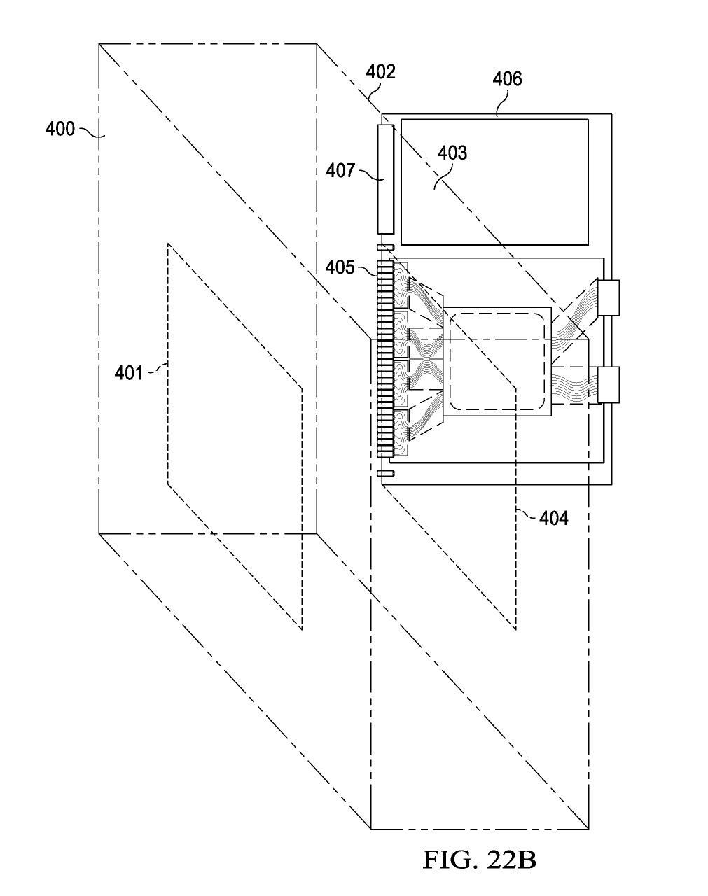

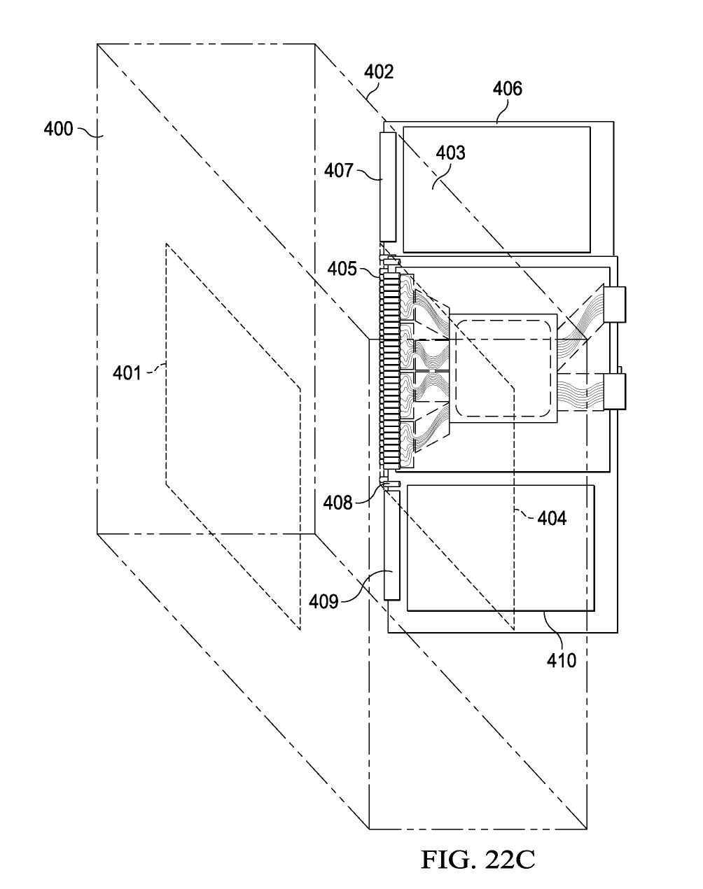

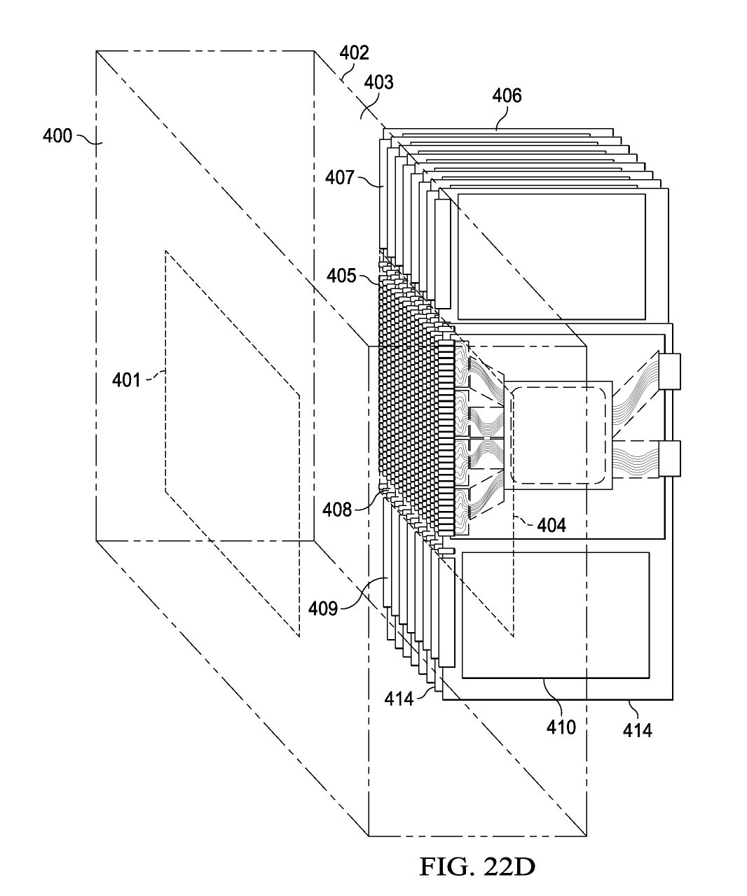

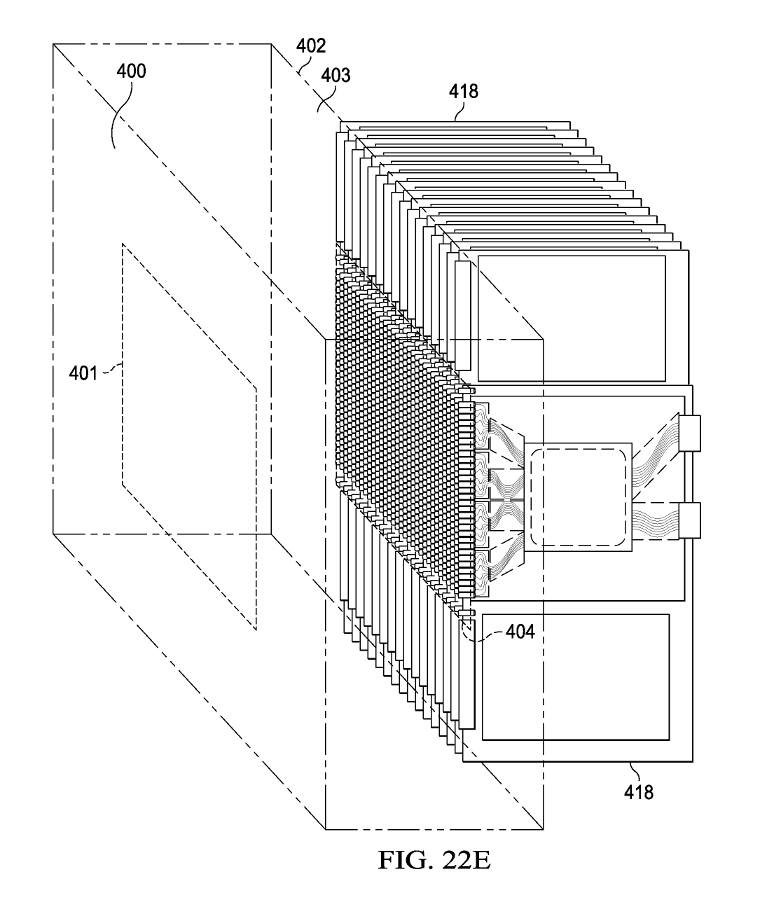

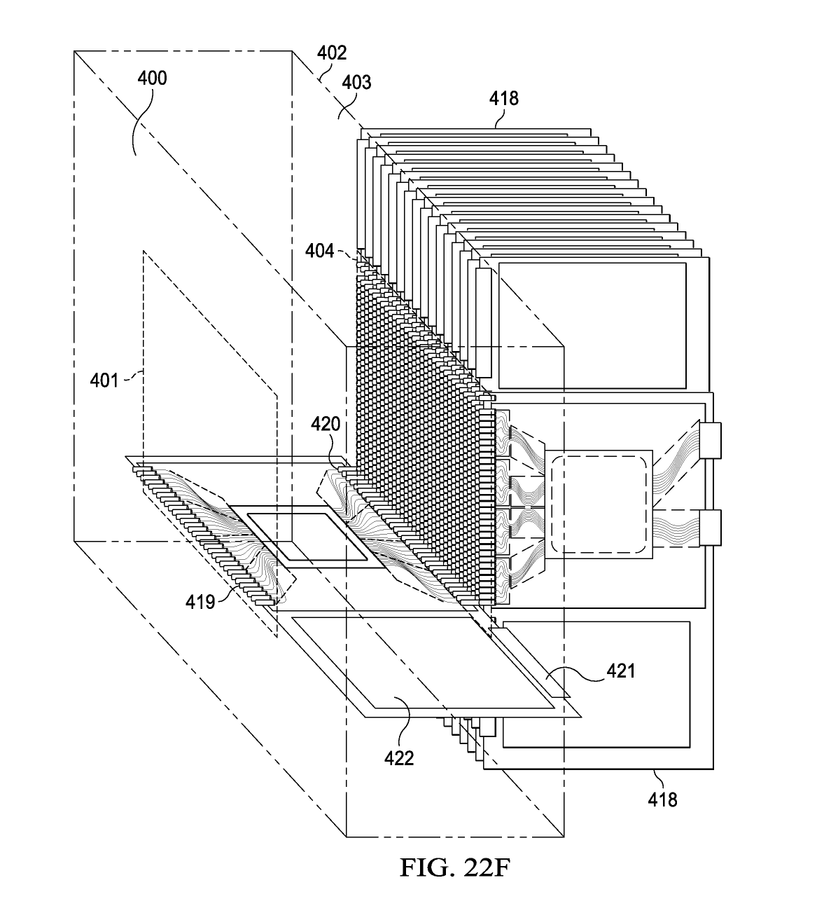

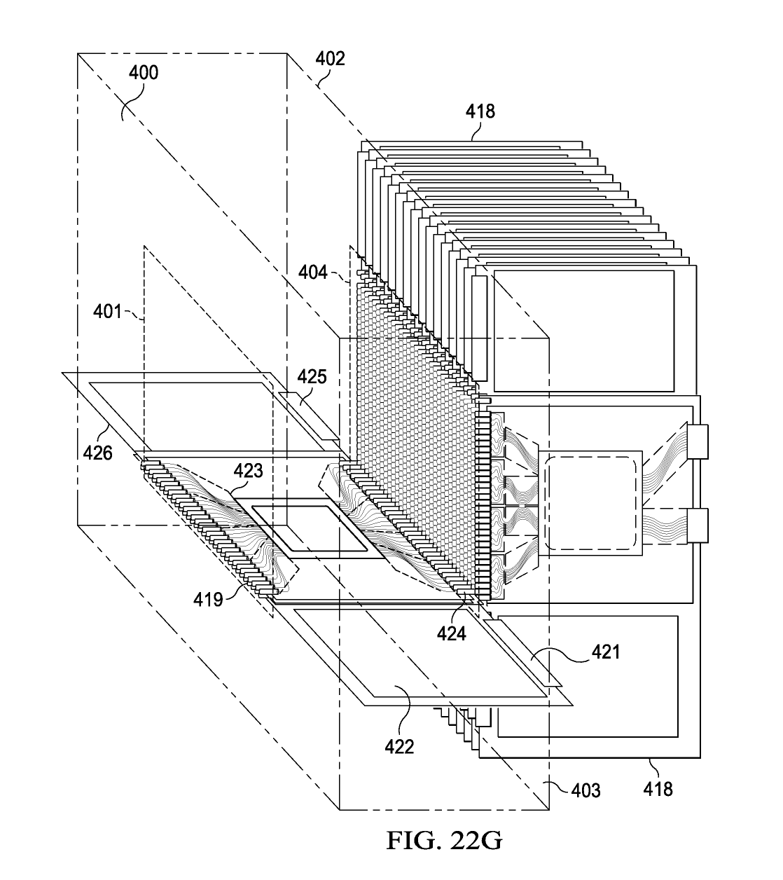

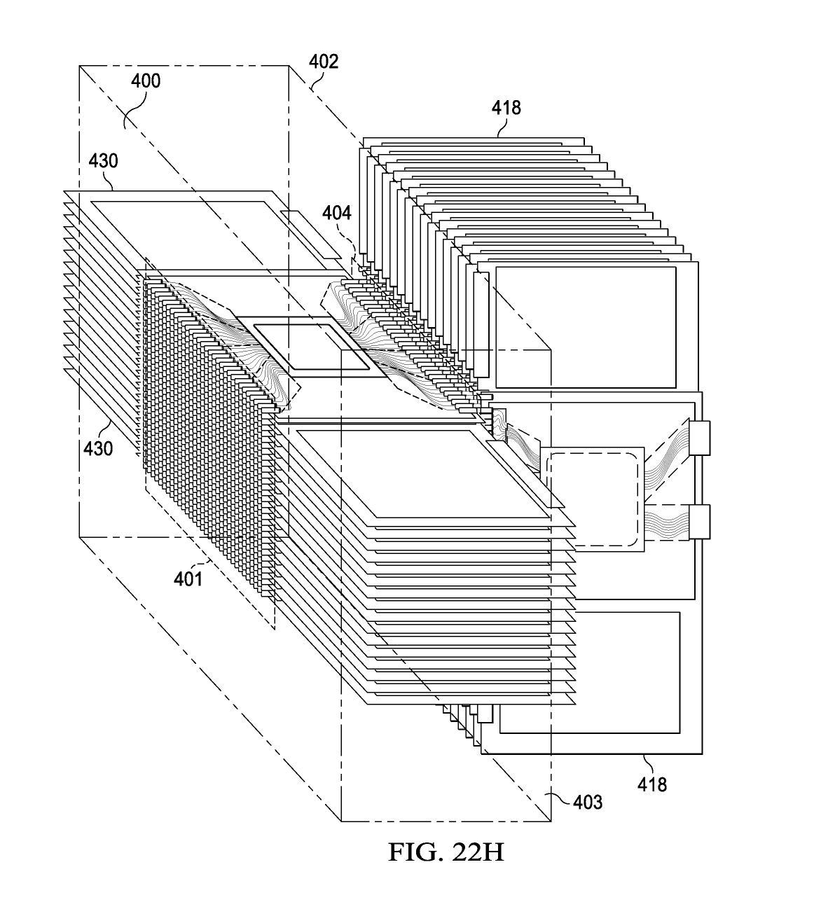

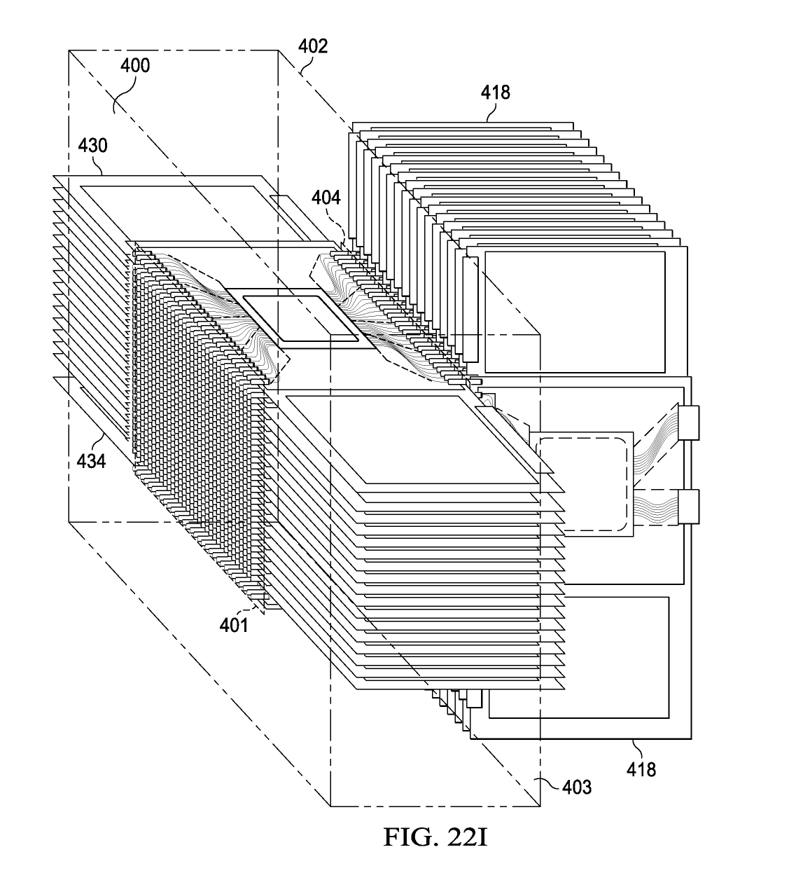

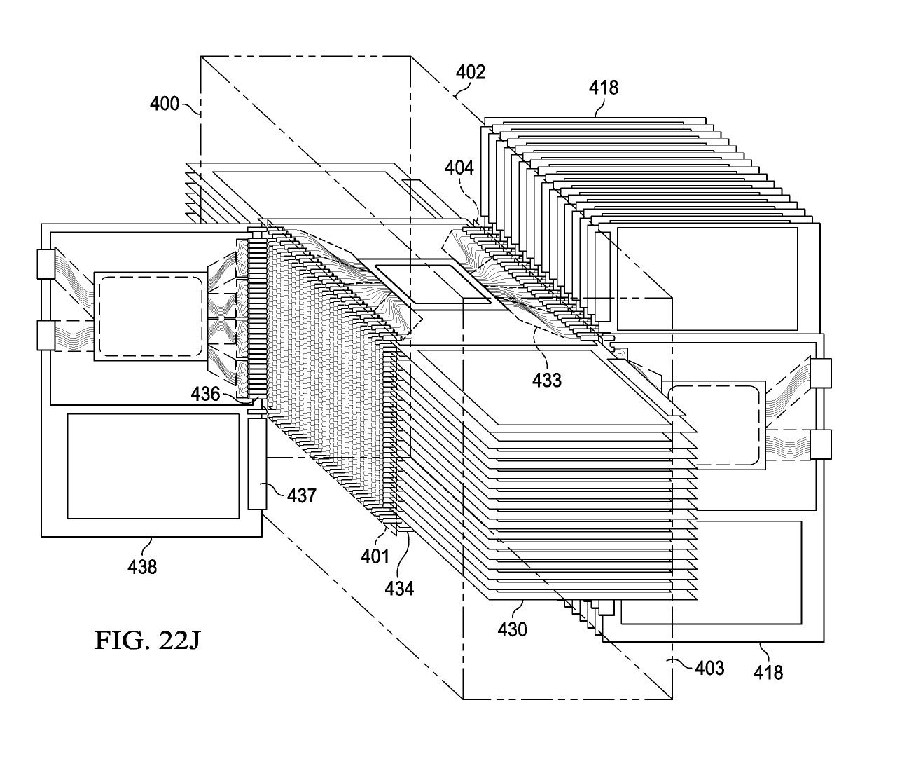

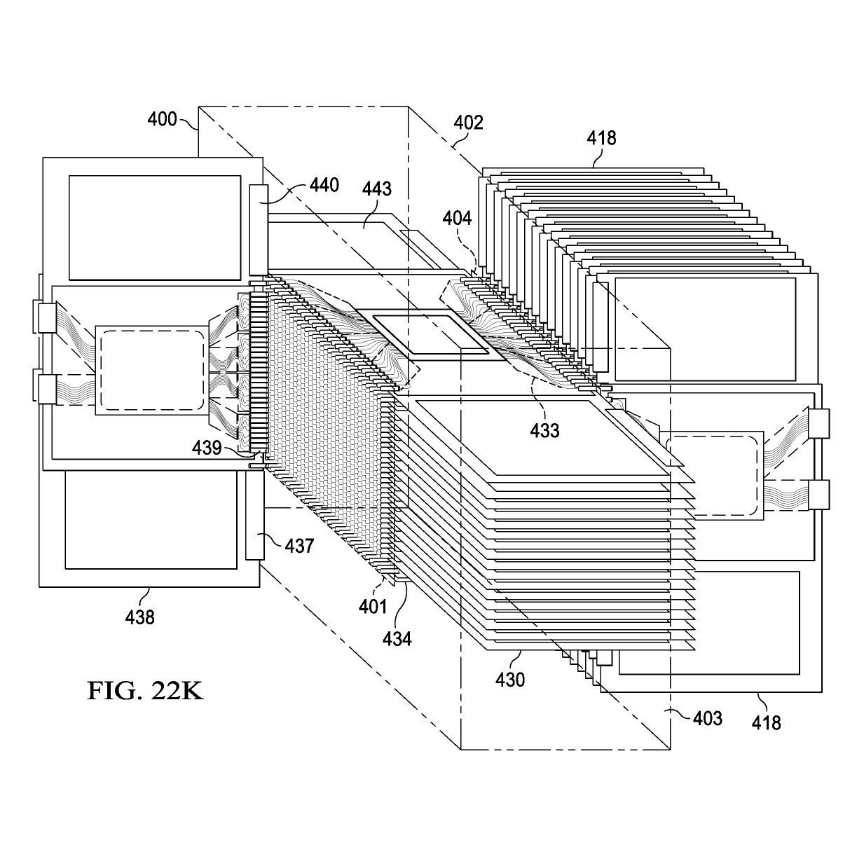

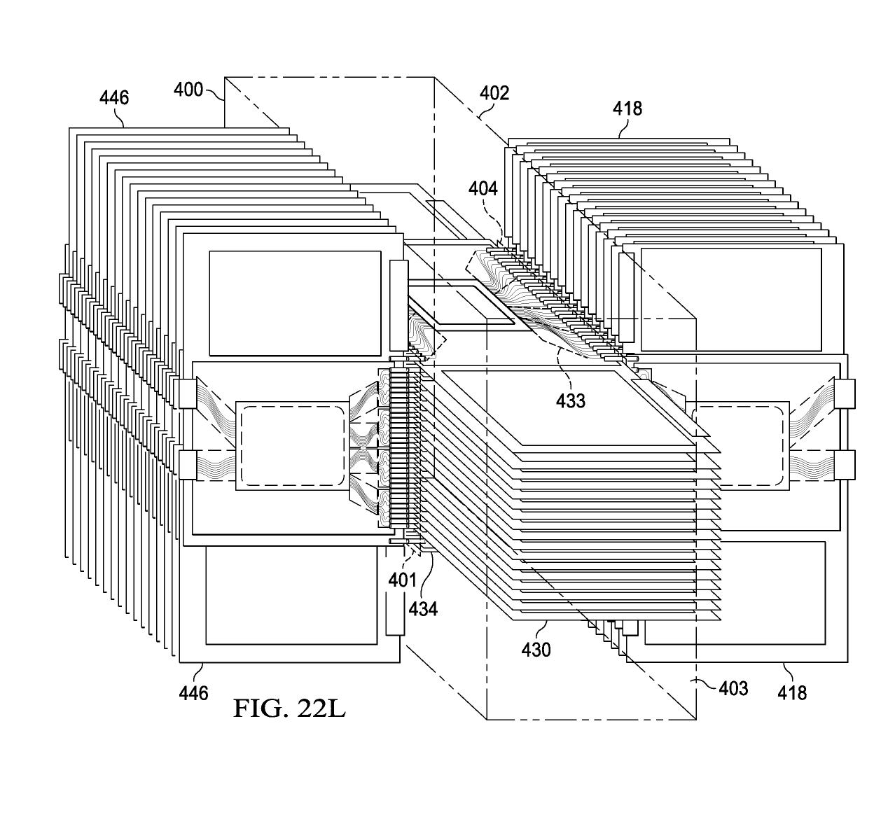

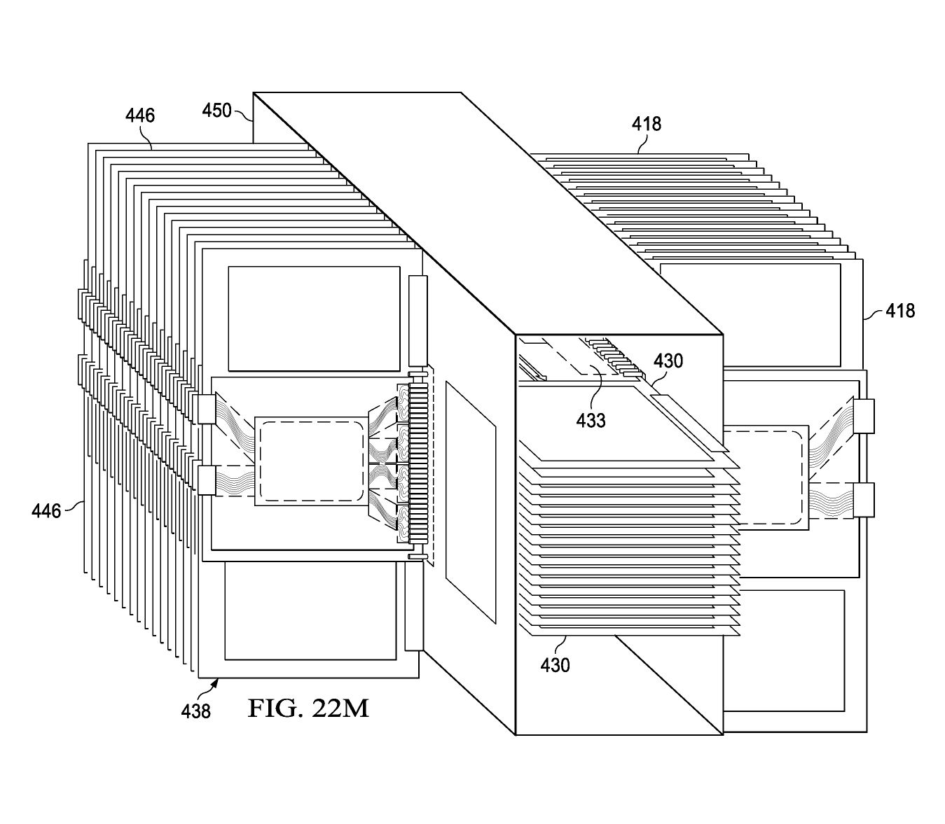

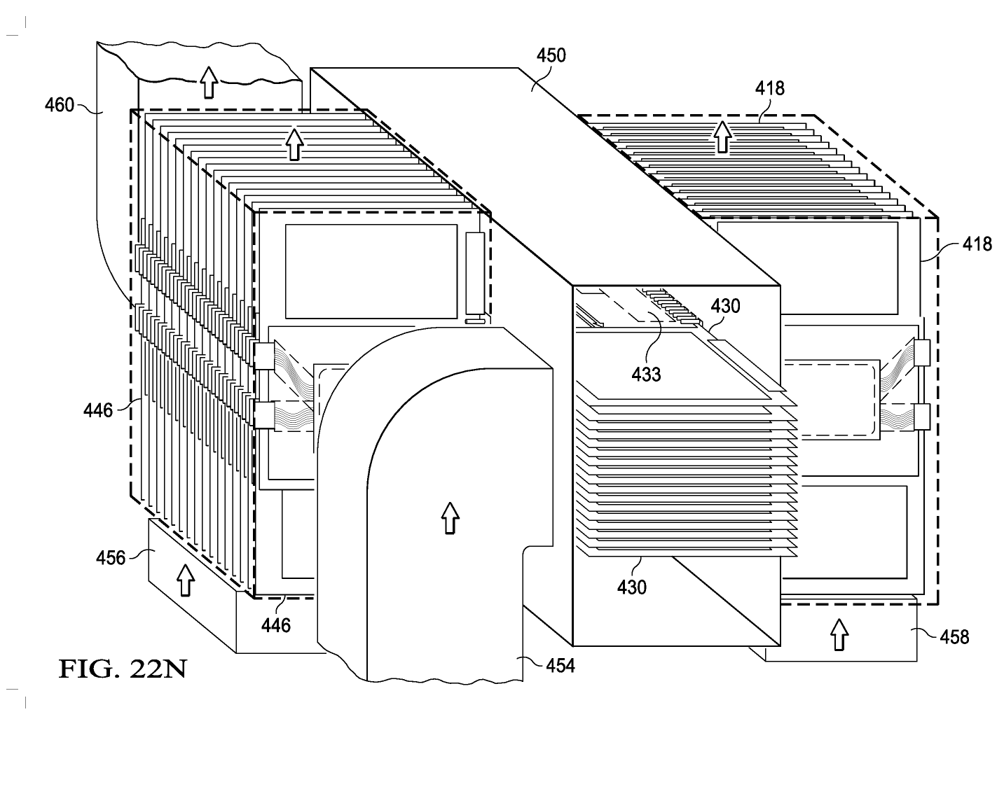

FIGS. 22A-N illustrate wire-frame drawings of building up a 1024×1024 non-dilating or 512×512 dilating photonic switching structure, the wire frame representation being used to illustrate the spatial relationships. The spatial relationships between the cards and other components are illustrated as the switch is built up. FIG. 22A illustrates wire frame 402 showing the mechanical structure of a photonic structure. Mid-plane 400 contains aperture 401 and mid-plane 403 contains aperture 404.

In FIG. 22B, a first output stage card 406 is inserted into wire frame 402. Electrical connector 407 is mated to mid-plane 403, while non-contact optical connector 405 protrudes through aperture 404 to mate with center stage cards. A guide structure (not shown) is used for precision guiding of the output stage cards.

FIG. 22C shows a second output stage card 410 inserted using a guide structure for precision guiding. Non-contact optical connector 408 is placed in aperture 404, while electrical connector 409 is mated to mid-plane 403 below aperture 404. Alternate electrical connectors are above and below aperture 404. Thus, the electrical pitch is double the photonic pitch.

In FIG. 22D, output stage cards 414, 16 of 32 optical output stage cards, are populated. Then, in FIG. 22E, output stage cards 418, 32 output stage cards, are populated. The mechanical optical card is aligned and latched with card guides and card cages (not shown).

FIG. 22F shows the insertion of the first center stage card 422. Non-contact optical connector 420 is in aperture 404, while retractable electrical connector 421 is in mid-plane 403 to the right of aperture 404. Non-contact optical connector 420 is aligned with non-contact optical connectors of the output stage cards by the action of the registration plate (not shown). Also, non-contact optical connector 419 is in aperture 401 of mid-plane 400. Center stage card 422 is slid horizontally into place across the face of mid-plane 403 and mid-plane 400 with the length sliding through the electrical connector. The optical area aperture is associated with a guide feature for the vertical alignment of the optical center stage connectors to the input stage and output stage connectors is adequate and horizontal alignment is achieved by a precision positive end-stop on the insertion. This end stop is part of the registration plate.

FIG. 22G shows the insertion of a second center stage card 426. Non-contact optical connector 423 of center stage card 426 is in aperture 401 of mid-plane 400, while non-contact optical connector 424 of center stage card 426 is in aperture 404 of mid-plane 403 to connect to non-contact optical connectors of the input stage cards. Electrical connector 425 of center stage card 426 is in mid-plane 403 to the left of aperture 404. Alternate electrical connectors of center stage cards are to the left of and to the right of aperture 404.

In FIG. 22H, 32 center stage cards 430 are inserted in the mid-plane structure. Each center stage card connects orthogonally to each output stage card in the optical connector field. Also, each output stage card optically connects orthogonally to each input stage card. The physical orthogonality of these units provides orthogonal interconnect with low delay on all paths without a fiber shuffle.

FIG. 22I shows the insertion of orthogonal mapping card 433 and orthogonal mapping card 434, which have retractable electrical connectors. The orthogonal mapper cards use expanded beam non-contact optical connectors to connect to the output stage cards and the input stage cards.

In FIG. 22J, the first input stage card 438 is inserted, with electrical connector 437 in mid-plane 400 below aperture 401 and non-contact optical connector 436 in aperture 401 directly coupling input stage card 438 to non-contact optical connectors of center stage cards 430 and orthogonal mapping cards 433 and 434. Each input stage card has an array of expanded beam optical non-contact connectors, which protrude through the aperture. Also, the input stage cards have a guide mechanism to approach within a fraction of a millimeter or a millimeter or two of the optical connectors of the center stage card.

FIG. 22K shows the second input stage card 442, with electrical connector 440 in mid-plane 400 above aperture 401 and non-contact optical connector 439 in aperture 401 providing direct optical connections to the center stage and orthogonal mapper cards. The electronic modules alternate sides.

The input stage modules 446 are fully populated with 32 units in FIG. 22L. The positions of the electrical contacts alternate. The switching fabric is fully populated.

FIG. 22M illustrates the central mechanical structure 450 which supports the mid-planes and will support the input stage and output stage card cages. Cages of card guides for the input stage cards and output stage cards may be attached to the outer faces of the two mid-planes to provide mechanical support and alignment and/or latching. These cages of card guides and supports are shown in FIG. 22N.

FIG. 22N also shows forced air cooling flows in an orthogonal photonic switching structure. First and output stage upper plenums, faceplates, and mechanical card/module guides are not pictured. Plenums 454, 460, 458, and 456 are pictured.

There may be cover plate(s) over the open vertical faces of the horizontally inserted center stage cards. These may be partitioned into strip plates or platelets to reduce air loss while changing cards.

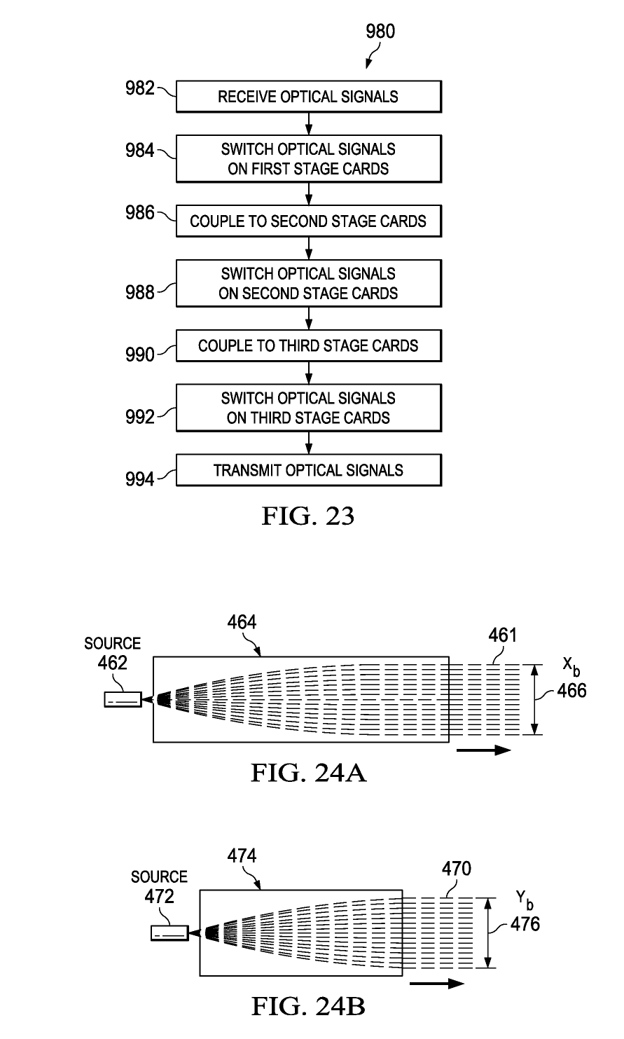

FIG. 23 illustrates flowchart 980 for an embodiment method of optical switching. Initially, in step 982, optical signals are received by the input stage cards. The optical signals may be received on optical fibers.

Next, in step 984, the optical signals are switched by the input stage optical cards, for example by optical crosspoint switches. The delays in the optical switching paths through the input stage optical cards low and have a low skew.

Then, in step 986, the switched optical signals from step 984 are coupled to the center stage cards. An array of non-contact optical connectors is used to couple each input stage card to each center stage card. The non-contact optical connectors may include two aligned GRIN lenses with an air gap between the GRIN lenses. The input stage optical cards are orthogonal to the center stage optical cards, facilitating a low delay and skew in the connection.

Next, in step 988, the optical signals are switched by the center stage optical cards. The optical signals may be switched using crosspoint optical switches or AWG-Rs. The optical paths through the center stage cards are short and have a low skew.

In step 990, the switched optical signals from step 988 are coupled to the output stage cards, which are orthogonal to the center stage cards. An array of non-contact optical connectors is used to directly couple each center stage card to each output stage card. The non-contact optical connectors may include two aligned GRIN lenses with an air gap between the GRIN lenses.

Then, in step 992, the optical signals are switched by the output stage cards, for example by optical crosspoint switches. The delays in the optical switching paths through the output stage optical cards are low and have a low skew.

Finally, in step 994, the switched optical signals from step 992 are transmitted, for example using optical fibers. The optical path lengths through the photonic structure a low delay and a low skew.

The waveguide in the macromodule substrate may have a very small cross-section, depending on the waveguide design and choice of waveguide material. An example silica waveguide has a width of from about 3 μm to about 8 μm. Some silicon waveguides may have sub-micron dimensions. These waveguides may be brought out to the substrate edge of the macromodules and directly coupled to the next stage modules. However, the small mode field diameter needs extreme precision in the alignment of the waveguides in the two substrates. Also, the macromodule edges would be in intimate contact with no air gap and may have significant losses.

In an embodiment, the mode-field is expanded in a mode field expander. The mode field expander is a tapered expanding cross sectional waveguide. The expanded beam is aligned to an edge fiber attach mechanism or a GRIN lens to create an expanded beam connector. The lens projects a nominally parallel sided beam which may be propagated in air.

The beam propagates about one to two millimeters across an air gap, when it impinges on another GRIN lens, which focuses the parallel beam to reconstruct the mode field spot. When the two GRIN lenses are identical, the reconstructed mode field spot is the same size as the source mode field spot. On the other hand, when the second GRIN lens is longer and has a larger diameter and increased focal length, the mode field spot on the received side is larger.

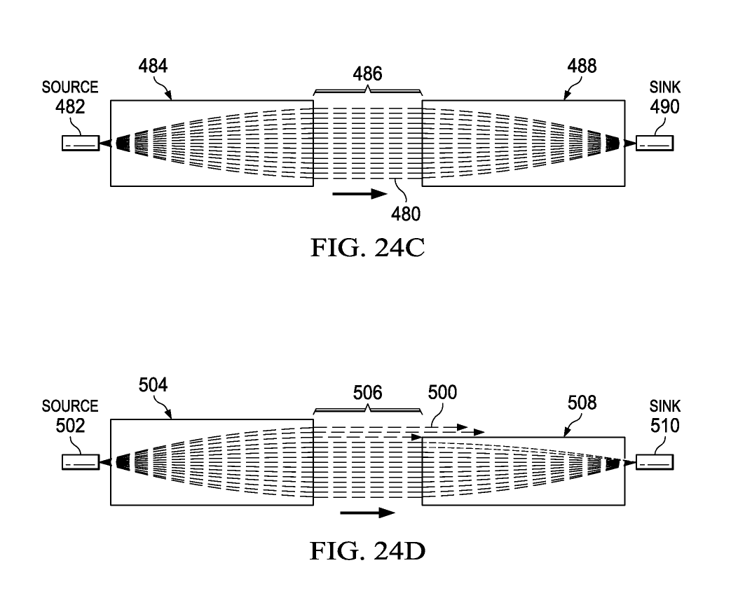

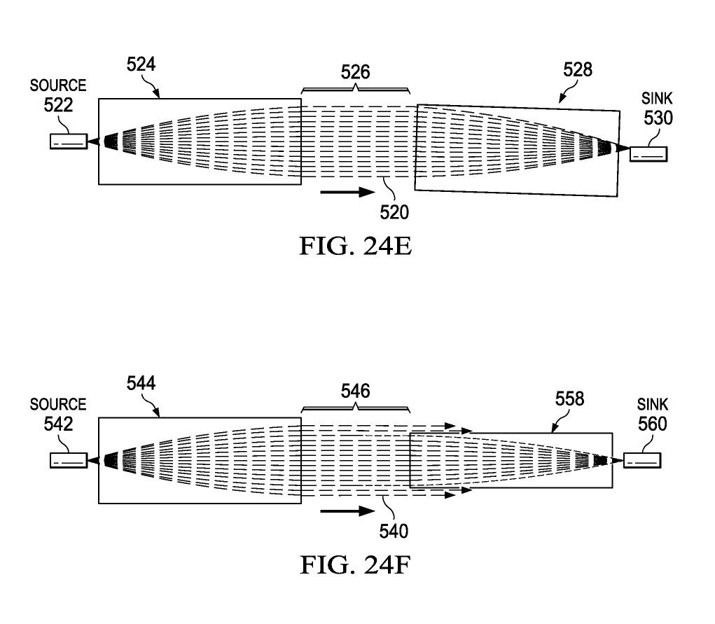

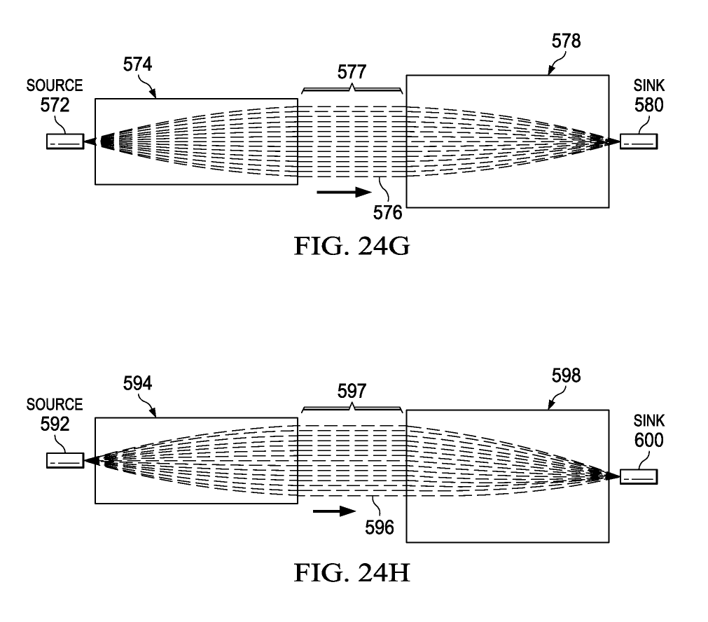

FIGS. 24A-H illustrate various GRIN lens configurations for non-contact optical connectors. In FIG. 24A, light from numerical aperture (NA) source 462 is coupled into GRIN lens 464 for a light beam 461 with diameter 466. FIG. 24B shows a projection from NA source 472 into GRIN lens 474 for light beam 470 with diameter 476. GRIN lens 474 has a larger diameter than GRIN lens 464.

FIG. 24C shows well aligned GRIN lenses of the same diameter. Light is coupled from light source 482 to GRIN lens 484. Light beam 480 propagates along air gap 486, and is coupled into GRIN lens 488, to light sink 490. GRIN lens 484 is similar to GRIN lens 488, and light source 482 has an NA similar to the NA of light sink 490. Also, GRIN lens 484 is aligned with GRIN lens 488.

FIG. 24D shows misaligned GRIN lenses of the same diameter. Light is coupled from light source 502 to GRIN lens 504, and light beam 500 travels along air gap 506. The light is partially received by GRIN lens 508, and is focused to light sink 510. As in FIG. 24C, light source 502 has a similar NA to light sink 510, and GRIN lens 504 is similar to GRIN lens 508. However, some light is lost, because GRIN lens 504 and GRIN lens 508 are not aligned.

FIG. 24E shows GRIN lenses with an angular offset. Light from light source 522 propagates through GRIN lens 524 and light beam 520 travels across air gap 526. The light enters GRIN lens 528, which is similar to GRIN lens 524, but at an angular offset to GRIN lens 524. The light is absorbed by light sink 530, which has a similar NA to light source 522. The light is at the edge of light sink 530, and some optical power will not couple into light sink 530, causing a loss of optical power. The destination beam spot may be easily further displaced to be outside of the light sink, which is problematic and leads to a loss of connection.

FIG. 24 shows light projected from a smaller GRIN lens to a larger GRIN lens which is aligned. Light from light source 542 propagates through GRIN lens 544 and light beam 540 propagates across air gap 546. Some of the light is coupled into GRIN lens 558, which is smaller than GRIN lens 544. Because the light beam in the air gap is wider than GRIN lens 558, some of the light is lost. The light in GRIN lens 558 is absorbed by light sink 560, which has a similar NA to light source 542.

On the other hand, FIG. 24G shows a light beam projected from a smaller GRIN lens to a larger GRIN lens which is properly aligned. Light from light source 572 propagates through GRIN lens. Light beam 576 travels along air gap 577 to GRIN lens 578. GRIN lens 578, which is aligned with GRIN lens 574, is larger than GRIN lens 574. The light is coupled into light sink 580 for further onward propagation.

FIG. 24H shows a light beam projected from a smaller GRIN lens to a larger laterally misaligned GRIN lens. Light from light source 592 propagates through GRIN lens 594. Light beam 596 propagates along air gap 597 to GRIN lens 598. GRIN lens 598, which is larger than GRIN lens 594, is also misaligned with GRIN lens 594. However, all of the light is received by GRIN lens 598, and focused on light sink 600, which has a similar NA to light source 592.

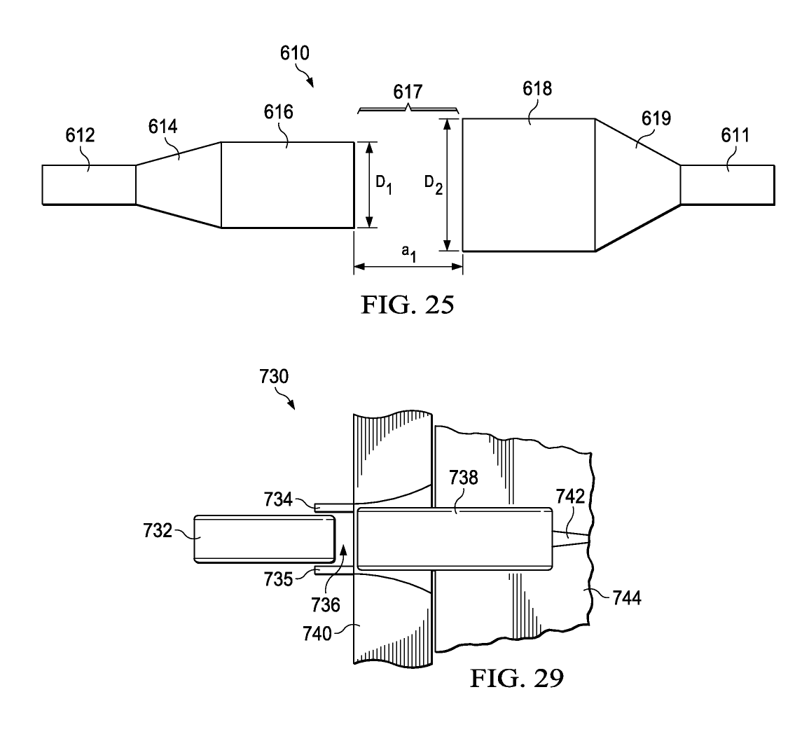

An embodiment uses a projection from a smaller lens to a larger lens. FIG. 25 illustrates non-contact optical connector 610. The mode field of macromodule waveguide 612 is expanded, for example to about 8-10 μm, by beam expander 614, and launched in GRIN lens 616 with a diameter D₁, creating a parallel sided beam of diameter d₁, which is projected across air gap 617 with a width of a₁ to impinge on the GRIN lens 618 with diameter D₂. This lens would have accepted a beam diameter d₂ and, due to its longer focal length, would have reconstituted a sharply focused spot with the same size as the source spot. However, because the lens receives a beam with a diameter d₁, the reconstructed mode spot is more diffuse, and somewhat larger. Hence, a mode field compressor, mode field compressor 619, operating from an input mode field in the region of about 15 μm and compressing the beam field may be used to focus light to macromodule waveguide 611. A mode field compressor is similar to a mode field expander, but operates in reverse. The mode field compressor may be a set of slowly tapering cross-section waveguides.

When lenses are laterally offset, using a receiving lens which is larger than the projecting lens may have better performance. FIG. 24D shows offset lenses with the same diameter, while FIG. 24G shows offset lenses where the receiving lens has a larger diameter than the projecting lens. When a larger receiving lens is use, as long as the projecting lens completely overlaps with the receiving lens, all the source light is captured and focused by the destination lens, although the mode spot is distorted by the offset. The focus for the receiving lens is in the same place, but, due to the distortion in the reconstruction of the mode field, it appears to lead to a larger, more diffuse mode, which may be captured by the larger mode field adaptor/compressor entry portal.

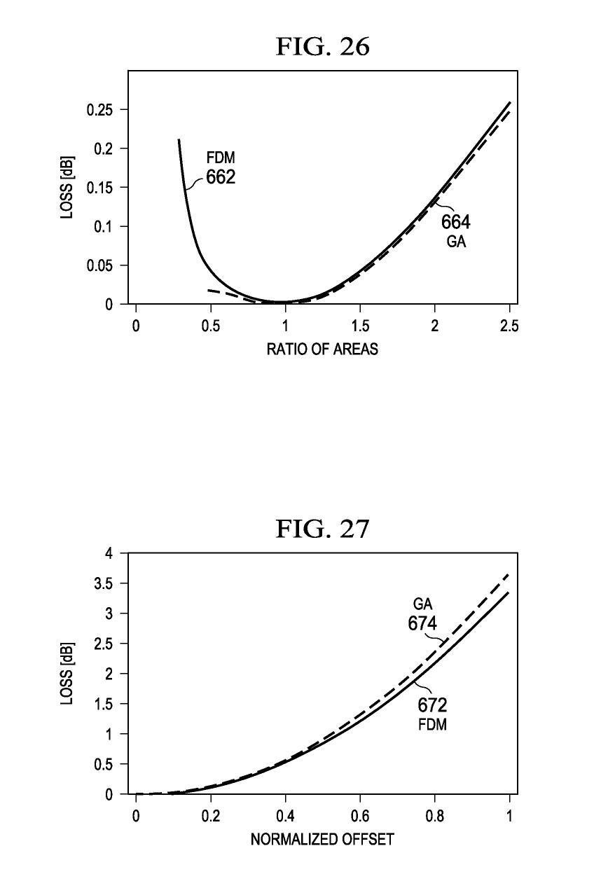

The use of dissimilar lens areas introduces an overall mismatch or loss in the connector, even when aligned. FIG. 26 illustrates a graph of the loss as a function of the ratio in areas from incomplete mode matching. Curve 664 shows the loss using the Gaussian Approximation (GA), while curve 662 shows the loss using the Fourier Decomposition Method (FDM). While the two methods are not identical, they are in close agreement. Doubling the optical area results in a loss of about 0.13 to about 0.14 dB.

FIG. 27 illustrates a graph of loss versus normalized offset, with curve 674 showing the loss with GA and curve 672 showing the loss with FDM. The loss increases by 3.34 dB for a normalized lens offset of one radius of the destination lens (1 mm for a 2 mm lens), about 2 dB at an offset of 0.75 radius, and around 1 dB for an offset of 0.5 radius when the projecting lens and receiving lens have the same diameter. When the receiving lens is larger, an offset of less than one diameter would have a smaller loss because either no or less light overlaps the larger receiving lens to be lost, and more light is available for mode spot reconstruction. Hence, with a 2 mm diameter receiving lens, an offset error of up to 0.75 mm leads to an excess loss less than 2 dB.

The two parts of the expanded beam non-contact connectors are aligned accurately to remain within these tolerances. The connector halves are carried on separate plug-in modules, one inserting conventionally and one slid into place across the face of mid-planes. In one example, to align the connectors of the vertically oriented input stage or output stage modules with the connectors of the horizontally inserted center stage modules, both halves of every connector associated with the first stage/center stage and second stage/output stage interfaces are aligned to a common registration detail or point on the mid-planes where these connectors meet.

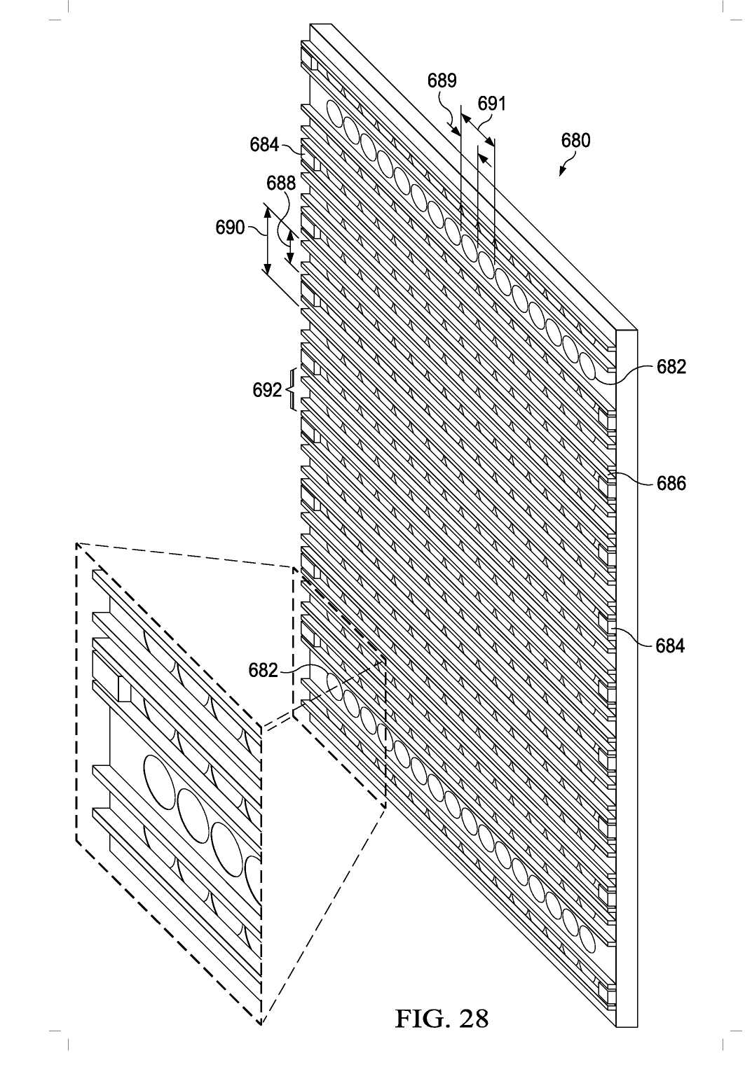

FIG. 28 illustrates registration plate 680, an example associated with each of the two mid-plane apertures. Registration plate 680 is for 16 input stage, 16 center stage, and 16 output stage cards, and two orthogonal mapper cards. A 32×32 version has 16 additional rows and 16 additional columns. The photonic modules of the center stage cards have pitch 688, while the electronic module of those cards has a pitch 690. The electronic pitch is twice the photonic pitch. The photonic modules of the input and output stage cards have a pitch 689 while the electronic modules of the same cards have a pitch of 691, where the electronic card pitch is twice that of the photonic card.

The registration plate is made from a highly stable material with approximately the same coefficient of expansion as the substrate controlling the GRIN lens pitch. Registration plate 680 has a precision two dimensional array of tapered holes 686, which are slightly larger than the non-contact optical connectors. The GRIN lenses may be in protective sleeves. One plate is fixed to each of the mid-planes, providing a reference guide into which the pluggable module (i.e. input and output stage modules) expanded beam optical connectors meet during the last part of the travel of the module down the plug-in card guides. Registration details 682, for example a metal spike, may be attached to either end of the macromodule row of expanded beam connector lenses. The registration detail enters the precision plate just before the expanding beam connectors, and tends to center the expanded beam connectors. Also, the lens array substrate may be resiliently mounted on the carrier to provide a small degree of compliance, so the overall pluggable input stage or output stage module position registration does not compete with the macromodule optical alignment to the aperture registration plate.

The registration plate is attached to the mid-plane so the non-contact optical connectors enter a series of tapering holes which, along with the registration detail, guide them to a known fixed position in the two axes of the plane of the mid-plane, with a tolerance relative to the registration plate, equivalent to the tapered hole positional tolerance plus spacing between the minimum hole diameter at the small end of the taper and the diameter of the expanded beam lens. To facilitate accurate spacing of the lenses, the lenses are mounted to the macromodule while held in a positional jig, relying on accurate inter-lens spacing, accurate lithography on the macromodule substrate, and the use of waveguide mode expanders to produce the required positional accuracy. The jig has a sufficiently tight tolerance for the row of lenses to be aligned to the substrate by aligning the lenses at each end. When this is achieved, the jig may have a higher tolerance than the margins in the registration plate-to-lens diameter tolerances, thereby avoiding binding the holes from the lens offset.

The center stage card is slide-inserted and aligned. The center stage non-contact optical connectors clear the mid-plane component of the electrical slid-in connector. This may be achieved by placing the optical connectors higher or lower than the electrical connectors, so they pass above or below the electrical connector as they slide in place. The optical connector may pass through the electrical component when the diameter is smaller than the opened connector slow width for a clamshell type connector which closes after module insertion. The clamshell action is either on the pluggable module or the backplane. In another example, the input stage and output stage expanded beam connectors protrude further through the registration plate, which may be mounted further into the center stage cavity than the mid-plane.

The slide-in non-contact optical connectors are aligned to the registration plate in two axes, the axis along which the plug-in module slides, and the axis orthogonal to this, up and down the mid-plane. The third axis, the distance between the two ends of the mating pair of the optical connector (the air gap) is handled by the tolerance of the two non-contact optical connectors for the size of the air gap. The air gap has a range which is more than the range of actual gaps. A parallel sided optical beam from a GRIN lens may be sent many tens of centimeters in air, for example in a three dimensional (3)D micro-electro-mechanical system (MEMS) switch, so an air gap of about 0.5 mm to about 2 mm is not problematic when there is no optical resonance in the air gap. Therefore the lens surfaces are anti-reflection coated to avoid resonances in the air gap.

The vertical alignment may be addressed by using lenses and/or registration details, such as a metal spike, which slide into a precision groove on the center stage module side of the registration plate. For example, groove 692 may be used. The groove is accurately positioned relative to the tapered holes, and is wider than the width of the expanded beam optical connector lenses or the registration detail, so it constrains them in a vertical direction to a tolerance based on the positional tolerances of the groove on the registration plate plus the slack or gap between the groove width and the lens diameter or registration detail diameter. The lenses are in a straight line without bow in the macromodule. Silica on silicon may be prone to bowing, because the two materials expand at a different rate. This may be reduced by growing a silica layer on the back of the silicon substrate of the macromodule.

The horizontal alignment along the slide-in path may be achieved using a precision end to the slide-in groove in the registration plate, for example end stop 684, so the face of the registration detail is stopped at the correct distance down the groove. A precision end stop for a single connector block per circuit pack side constrains the center stage connectors horizontally. For multiple connector blocks, a graduated or stepped groove width with precision taper end stops may be used. There is a tolerance between the groove end on the input stage slide and the groove on the output stage side. When the macromodule is mounted slightly resiliently, and is pressured into the direction of the insertion, when it reaches the end stops of the grooves, it rotates a small fraction of a degree to simultaneously pick up on both end-stops. This causes the center stage macromodule to be slightly twisted, but does not have a significant impact on the alignment of the expanded beam connector components.

FIG. 29 illustrates second mid-plane detail 730. Tapered waveguide 742, which is in macromodule 744 or at the end of a flexible optical link from a macromodule, is fed from GRIN lens 738, in this example a 2 mm diameter and 5.7 mm long GRIN lens in its final position. GRIN lens 738 has entered a precision tapered hole in registration plate 740, a 2 mm thick registration plate, and is now centered in the tapered hole in that plate, with a tolerance determined by the slack between the hole diameter and the lens diameter. The two guides 734 and 735 of a horizontal groove create a groove or channel with a width slightly greater than that of the slide-in GRIN lens 732. This groove is centered vertically on the hole in the registration plate. Hence, GRIN lens 732 is aligned vertically to be approximately vertically centered on GRIN lens 738, within the tolerances generated by the slack between the two lenses and their respective constraints from the registration plate. The horizontal alignment (in and out of the page in FIG. 29) is determined by the GRIN lens module and the end stop 684 on the registration plate, where the precise spacing of the GRIN lenses is due the GRIN lens carrier substrate. GRIN lens 732 is a 1.4 mm diameter and 4.7 mm long GRIN lens. Air gap 736 is between GRIN lens 738 and GRIN lens 732. GRIN lenses 738 and 732 have an anti-reflective coating. In a six inch/15 cm wide center stage module with a difference in the end stop position of 0.5 mm, there is an offset angle of 0.000582 degrees, which, across a 1 mm air gap, produces a positional error of 3.3 μm in a connector system with a misalignment tolerance, for example, up to 0.5 mm. This facilitates light propagation with low loss from GRIN lens 732 to GRIN lens 738 even with some lateral misalignment. There is a higher loss in the reverse direction, where some optical power can be more readily lost, and hence losses with lateral offset would be higher.

Along the groove, components include a input stage or output stage lens, with a registration plate hole tolerance and slack of Lₕ, while the registration plate manufacturing tolerance in the horizontal direction, from the groove end reference to the center of the registration plate along the groove is Rₕ. Also, in the horizontal direction, the center stage lens position-registration detail position tolerance is Cₕ. The vertical direction across the groove, the tolerances include the input stage or output stage lens-registration plate hole tolerances and slack of Lᵥ, the registration plate manufacturing tolerances in the vertical direction, in the groove vertical tolerances and slack and the centering of the groove on the registration plate holes is Rᵥ, and the center stage lens position-registration detail position tolerance is C. The overall horizontal tolerance is given by:

Tₕ=L_{b}+Rₕ+Cₕ,

and the overall vertical tolerance is given by:

Tᵥ=Lᵥ+Rᵥ+Cᵥ.

For the lens axes to be aligned within a distance Da:

Dₐ²=Tₕ²+Tᵥ².

When Tₕ=Tᵥ=T:

Dₐ=T\sqrt{2}.

The individual tolerances and the target value for Dₐ may be set by the design of the lens system. In one example, a 1.8 mm GRIN lens has an about 6 mm connection pitch, with a registration plate hole array area of about (6)*32=192 mm, or about 6.6 inches on a side, while the electronics cards may have a pitch of about 12 mm. This leads to a photonics card pitch of about 6 mm, for a registration plate of about 192 mm square. The overall packaging density is may be limited by the electronics pitch.

The center stage module slides through the mid-plane electrical connector and makes contact through mating connections with the electrical connector. This may be achieved by retracting the electrical connections on one part of the two mating parts of each of the mating connectors, and advancing the connections again once the module is inserted. Such connectors have been known since the early 1980s when they were explored as a solution to connector insertion forces before low insertion force connectors were developed.

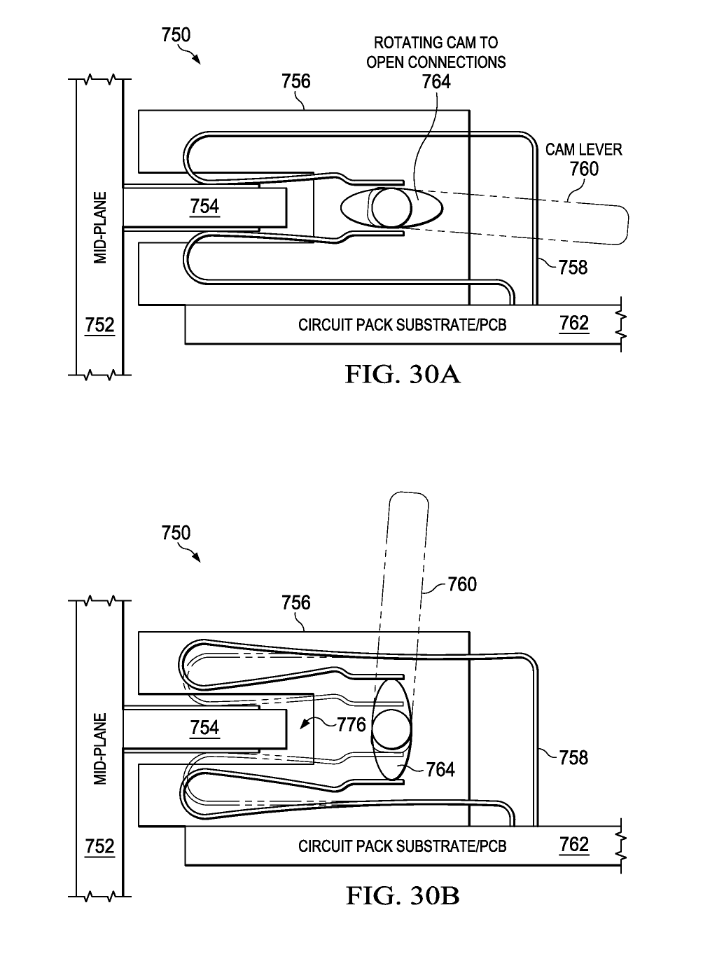

FIGS. 30A-B illustrate card edge connector 750, an example a retractable electrical connector. In FIG. 30A, the retractable electrical connector is in the in-service position. Mid-plane 752, which contains mating connector 754, is in opening 776 in card 756. Electrical connections 758 contacts mating connector 754. Card 756 is mounted on substrate 762, a circuit pack substrate or PCB. Rotating cam 764 is attached to cam lever 760. FIG. 30B shows card edge connector 750 with connections retracted for insertion or removal. Rotating cam 764 is rotated using cam lever 760, so there is not an electrical connection. The center stage card is inserted with the electrical connectors retracted, and they are moved to the in-service position after insertion.

The macromodule substrate may be silicon or silica on silicon. For small switching modules with limited port counts, the macromodule may act as a carrier and interconnect for the photonic functionality, as well as providing the optical tracking to the inter-module connectors. For high port count switches, the length of the inter-module connector array becomes large, and the macromodule is sized to provide only the interconnect, monolithic components and integrated components hybridization of the switch stage photonic functionality, with the interconnect to the inter-stage connectors such as the GRIN lens connectors being provided by precision extensions as detailed in FIGS. 10 and 11A-B. The physical size of the macromodule is no smaller than that for the photonic functionality and optical coupling in and out of the macromodule, leading to macromodule sizes in the range of 47×47 mm up to 67×67 mm for the three stages of a 1024×1024 polarization agnostic switch. Specific areas of the macromodule substrate support local precise registration of hybridized-on components.

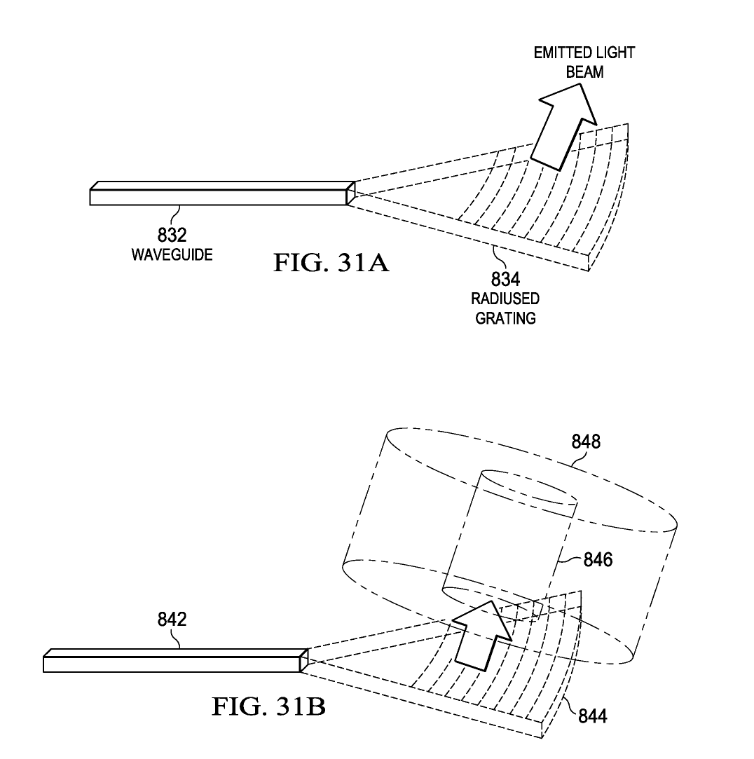

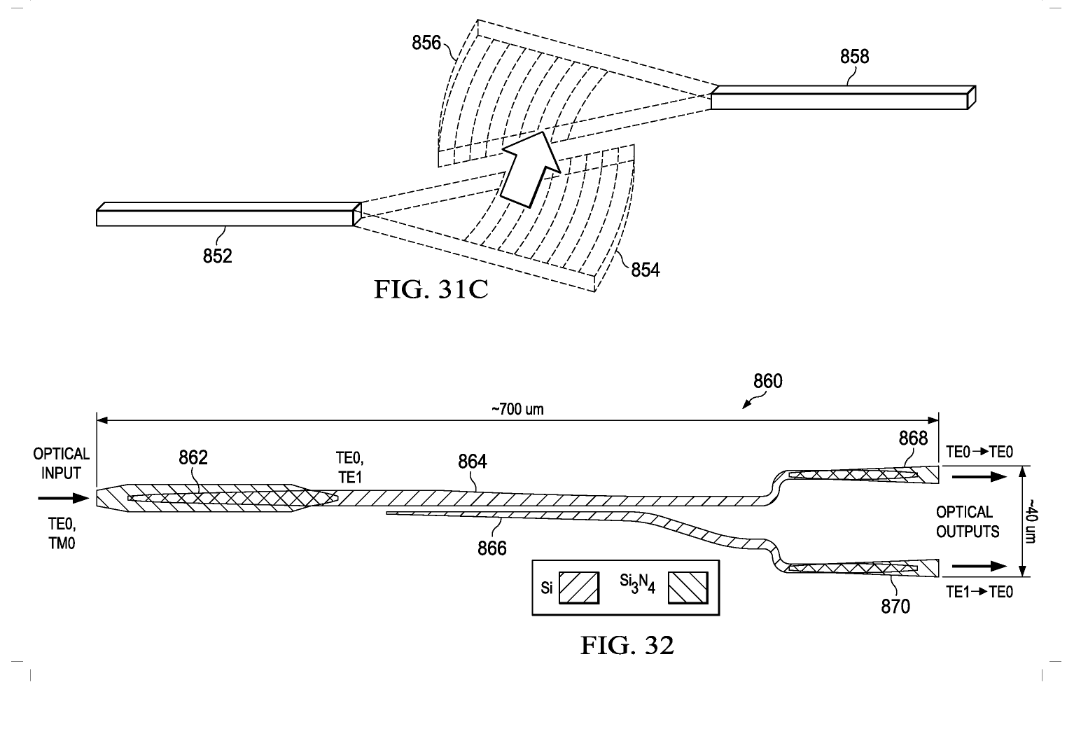

There both optical and electrical coupling to and from the macromodule from the hybridized components. In one example, illustrated by FIGS. 31A-C, a tapered diffraction grating on the substrate causes beaming out of the waveguides of the substrate at a significant angle, close to normal to the substrate, and captures the light on the hybridized component via another tapered diffraction grating. In FIG. 31A, light from waveguide 832 on radiused waveguide grating 834 causes an emitted beam. In FIG. 31B, light propagates along waveguide 842 and is emitted from radiused grating 844 to an optical fiber with core 846 and cladding 848. In FIG. 31C, light is coupled between hybridized Si-PIC and a macromodule substrate. Light is coupled between waveguide 852 with radiused grating 854 and waveguide 858 with radiused grating 856. Light may be coupled in both directions. Other coupling approaches between the macromodule substrate and the hybridized components include 45-57 degree angled micro-mirrors and closely coupled waveguides on the two components being joined. These coupling techniques may also couple into or out of the flexible precision waveguide extensions to and from the inter-stage and input/output connectors.

Polarization splitting, combining, and rotation functions are performed, for example directly on the macromodule substrate. One example silicon nitrate on silicon-on-insulator (SOI) polarization splitter based on TM0-TE1 mode conversion, such as waveguide 860 illustrated in FIG. 32 may be used. Regions 862, 868, and 870 are made of silicon nitrate, while regions 864 and 866 are made of silicon.

Amplification may be achieved by hybridizing semiconductor optical amplifier arrays and their controllers on the substrate. Alternatively EDWAs are built into the substrate. An EDWA array uses a high power 980 nm optical pump source rather than an electrical power source for SOAs.

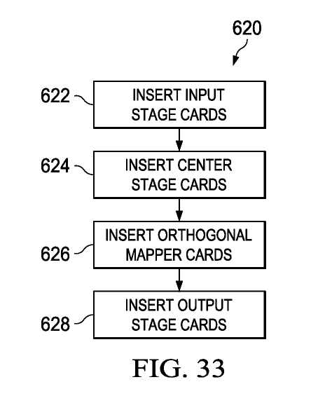

FIG. 33 illustrates flowchart 620 for an embodiment method of building a photonic structure. Initially, in step 622, input stage cards are inserted into a mechanical structure with mid-planes. Electrical connectors and optical non-contact connectors are inserted in to a first mid-plane. The optical connectors are plugged in to a registration plate in an aperture in the mid-plane. As alternate cards are inserted, the electrical connectors are on alternate sides of the optical connectors.

Next, in step 624, the center stage cards are inserted between the two mid-planes. The center stage cards are slid between the two mid-planes. Retractable electrical connectors are retracted during insertion. Optical non-contact connectors are aligned with the optical non-contact optical connectors in the input stage cards, so each center stage card is directly optically connected to each input stage card. The optical connectors are aligned using the registration plate in the aperture of the mid-plane. Alternate center stage cards are inserted with the electrical connectors above and below the optical connectors. The center stage cards have two sets of optical non-contact connectors on opposite sides of the card to directly couple to the input stage cards and the output stage cards. Both are aligned using registration cards in an aperture in the corresponding mid-plane.

Then, in step 626, orthogonal mapper cards are inserted. In one example, two orthogonal mappers are inserted. In one example, one orthogonal mapper card is inserted above the center stage cards, and the other orthogonal mapper card is inserted below the center stage cards. In another example, the orthogonal mapper cards are all at the top, all at the bottom, or interspersed with the center stage cards. The orthogonal mapper cards have a retractable electrical connector which is retracted while the orthogonal mapper cards are slid between the two mid-planes. The orthogonal mapper cards also have optical non-contact connectors on opposite sides, which are aligned using registration plates in apertures in the mid-planes. The orthogonal mapper cards all have a direct optical connection to each input stage card and each output stage card.

Finally, in step 628, the output stage cards are plugged in to the second mid-plane. The output stage cards have an electrical connector, which is plugged in to the mid-plane, and an optical non-contact connector, which is inserted in to the registration plate in the aperture of the mid-plane. Each output stage card is directly optically connected to each center stage card and each orthogonal mapper card. The electrical connectors are alternately above and below the non-contact optical connectors.

Sub-equipped lower capacity switches may omit the insertion of a portion of each set of cards in each stage. When X % of input and output cards are provisioned and ≧X % of center stage cards are provisioned to maintain dilation levels, the resultant switch capacity is X % of the maximum. Hence, when 26 of 32 input and output cards are provisioned the switch capacity is 81.25% of the maximum capacity.

An embodiment macromodule for a center stage switching card includes two 32×32 crosspoint chips, 32 polarization splitters and rotators, 32 polarization rotators and combiners, and 64 SOAs. With core chip size is 13 mm×13 mm for a crosspoint chip, plus 3 mm for output coupling to the substrate, there are two 16 mm×16 mm chips for an area of 256 square mm each, or 512 square mm total. The 32 polarization rotators and splitters are about 1.3 mm×0.3 mm or less, for an overall area of around 0.4 square mm to around 0.5 square mm per device, or about 16 square mm for the 32 devices. The polarization rotators and combiners have areas similar to the polarization splitters and rotators. Hence, the overall polarization processing functions may be about 32 square mm, or about 32 square mm to about 50 square mm with a margin. The 64 SOAS may be about 1-2 square mm each as discrete chips, for a total of about 64 square mm to about 128 square mm. The total area budget is about 608 square mm to about 690 square mm, which may be rounded up to about 700 square mm. The dense optical interconnect to link the functions together is conservatively about 2100 square mm, for a total of 2800 square mm.

The area of the active functions plus the interconnect is around 50 mm to about 70 mm squared, which is much smaller than the size for the connector field for the aperture. There may be a high density optical design of the active macromodule area in the center of a less optically dens larger overall area, so the optical waveguides are tracked out to V-groove mounted expanded beam connectors. Alternatively, the macromodule size is limited to that of the photonic functions and the compliant waveguide array is used to extend in a controlled path length environment out to the expanded beam lens carriers at the overall module edge.

An embodiment packaging approach exploits the use of macromodules at the system level for low skew and delay photonic switch. The low skew facilitates a high bit rate of photonic packet and/or container switching in a fast synchronous space switch. The overall fabric timing and skew behavior is compatible with a 100 Gb/s packet or encapsulated packet stream switching individual long containerized packets. A frame format mapping one long packet or padded long packet into a nominally 120 ns frame with a 3-5% clock acceleration yields a commutation platform with a clock rate of about 120%.

An embodiment packaging approach facilitates a three stage photonic switch, for example using a CLOS configuration, where the first stage is implemented by a macromodule-based solution. The first stage may provide 1:2 dilation for a non-blocking CLOS switch fabric. In one example, the center stage has a slide in mounting to be physically orthogonal to the first stage, for example using a macromodules. The third stage may be implemented in a similar manner to the first stage. This configuration yields a three stage CLOS switch which, due to the lithographic control in the macromodules and the low inter-stage skew from the direct stage to stage optical connections and orthogonal physical packaging, may have low skew. This facilitates a low intrinsic switched path-to-switched path skew. This facilitates the operation of the switch at 100 Gb/s with standard IPGs or ICGs.

An embodiment photonic structure includes a plurality of input stage cards including a first input stage card and a second input stage card, where the first input stage card is parallel to the second input stage card, where a first plane is at an edge of the plurality of input stage cards, and where the first plane is orthogonal to the plurality of input stage cards. The photonic structure also includes a plurality of center stage cards optically coupled to the plurality of input stage cards, where the plurality of center stage cards includes a first center stage card and a second center stage card, where the first center stage card is orthogonal to the first input stage card and the second input stage card, where the second center stage card is orthogonal to the first input stage card and the second input stage card, where the first plane is at a first edge of the plurality of center stage cards and orthogonal to the plurality of center stage cards, where a second plane is at a second edge of the plurality of center stage cards, where the second plane is parallel to the first plane, where the first center stage card is directly optically coupled to the first input stage card and the second input stage card, and where the second center stage card is directly optically coupled to the first input stage card and the second input stage card. Additionally, the photonic structure includes a plurality of output stage cards optically coupled to the plurality of center stage cards, where the plurality of output stage cards includes a first output stage card and a second output stage card, where the first output stage card is orthogonal to the first center stage card and the second center stage card, where the second output stage card is orthogonal to the first center stage card and the second center stage card, where the second plane is at an edge of the plurality of output stage cards, where the second plane is orthogonal to the plurality of output cards, where the first output stage card is directly optically coupled to the first center stage card and the second center stage card, and where the second output stage card is directly optically coupled to the first center stage card and the second center stage card.

In one example, a first optical path length is through the first input stage card, from the first input stage card to the first center stage card, through the first center stage card, from the first center stage card to the first output stage card, and through the first output stage cards, where a second optical path length is through the second input stage card, from the second input stage card to the second center stage card, through the second center stage card, from the second center stage card to the second output stage card, and through the second output stage cards, and where a difference between a length the first optical path and a length the second optical path length is less than one ns.

In another example, a plurality of optical path lengths through input states of the plurality of input stages, center stages of the plurality of center stages, and output stages of the plurality of output stages is within one ns.

In an additional example, an optical path through the first input stage card, from the first input stage card to the first center stage card, through the first center stage card, from the first center stage card to the first output stage card, and through the first output stage card has a propagation delay of less than 5 ns.

In a further example, the first center stage card includes a first photonic module and a first electrical module on a first surface, where the second center stage card includes a second photonic module and a second electrical module on a second surface, where the first surface is parallel to the second surface, where the first photonic module is directly over the second photonic module, and where the first electrical module is not directly over the second electrical module.

In an example, the first input stage card includes a first photonic module and a first electrical module on a first surface, where the second input stage card includes a second photonic module and a second electrical module on a second surface, where the first surface is parallel to the second surface, where the first photonic module is directly over the second photonic module, and where the first electrical module is not directly over the second electrical module.

In another example, the first output stage card includes a first photonic module and a first electrical module on a first surface, where the second output stage card includes a second photonic module and a second electrical module on a second surface, where the first surface is parallel to the second surface, where the first photonic module is directly over the second photonic module, and where the first electrical module is not directly over the second electrical module.

In a further example, the first center stage card of the plurality of center stage cards includes a first non-contact optical connector directly coupled to the first input stage card and a second non-contact optical connector directly coupled to the first output stage card.

In an additional example, the first center stage card includes a strength plate, a photonic module disposed on the strength plate, and an optical module disposed on the strength plate.

An example further includes an orthogonal mapper card directly optically coupled to the plurality of input cards and the plurality of output cards.

An example also includes a first mid-plane electrically coupled to the plurality of input stage cards and the plurality of center stage cards and a second mid-plane electrically coupled to the plurality of output stage cards and the plurality of center stage cards. This example may also include a mid-plane interconnect coupled between the first mid-plane and the second mid-plane. Additionally, the first mid-plan includes a plurality of retractable multi-pin electrical connectors coupled to the plurality of center stage cards. The first mid-plane also includes an aperture, where a plurality of non-contact optical connections is between the plurality of input stage cards and the plurality of center stage cards are in the aperture. In an example, the plurality of input stage cards include a first switching stage, where the plurality of center stage cards include a second switching stage, and where the plurality of output stage cards include a third switching stage.

In an example, the plurality of center stage cards are optically coupled to the plurality of input stage cards by a first plurality of two part non-contact expanded beam optical connectors, and where the plurality of center stage cards are optically coupled to the plurality of output stage cards by a second plurality of two part expanded beam non-contact optical connectors, and where first center stage card includes a retractable electrical connector.

An example also includes a first registration plate mechanically coupled between the plurality of input stage cards and the plurality of center stage cards and a second registration plate mechanically coupled between the plurality of center stage cards and the plurality of output stage cards.

An embodiment optical connection includes a first array of holes on a first side of a registration plate and an array of grooves having a plurality of end stops on a second side of the registration plate. The optical connection also includes a first plurality of graded refractive index (GRIN) lenses inserted into the first array of holes, where the first plurality of GRIN lenses includes a first GRIN lens in a first hole of the first array of holes and a second plurality of GRIN lenses inserted in grooves of the array of grooves, where the first side of the registration plate is opposite the second side of the registration plate, where the second plurality of GRIN lenses includes a second GRIN lens in a first groove of the array of grooves opposite the first GRIN lens, and where the first GRIN lens is optically coupled to the second GRIN lens by an air gap in the first hole.

In one example, the first GRIN lens has a first diameter, where the second GRIN lens has a second diameter, and where the first diameter is smaller than the second diameter, and where the first lens is configured to propagate light to the second lens.

In another example, the second plurality of GRIN lenses is configured to slide in along the array of grooves.

An embodiment registration plate includes a row of holes and a groove configured to receive a card along the row of holes, where the card includes a row of non-contact optical connectors, and where the groove is configured to align the row of non-contact optical connectors with the row of holes. The registration plate also includes an end stop at an end of the groove, where the end stop is configured to align the row of non-contact optical connectors with the row of holes.

An example also includes a plurality of registration details above the row of holes.

An embodiment device includes an optical macromodule and a plurality of flexible waveguide extensions having a surface. The device also includes a plurality of graded refractive index (GRIN) lenses, where the plurality of flexible waveguide extensions are optically coupled between the optical macromodule and the plurality of GRIN lenses.

An embodiment also includes an electrical module electrically coupled to the optical macromodule and a retractable electrical connector electrically coupled to the electrical module.

In an additional example, the plurality of flexible waveguide includes optical connectors, where the plurality of flexible waveguides is bowed in orthogonal to the surface and parallel to the optical connector.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A photonic structure comprising:
a plurality of input stage cards comprising a first input stage card and a second input stage card, wherein the first input stage card is parallel to the second input stage card, wherein a first plane is at an edge of the plurality of input stage cards, and wherein the first plane is orthogonal to the plurality of input stage cards;
a plurality of center stage cards optically coupled to the plurality of input stage cards, wherein the plurality of center stage cards comprises a first center stage card and a second center stage card, wherein the first center stage card is orthogonal to the first input stage card and the second input stage card, wherein the second center stage card is orthogonal to the first input stage card and the second input stage card, wherein the first plane is at a first edge of the plurality of center stage cards and orthogonal to the plurality of center stage cards, wherein a second plane is at a second edge of the plurality of center stage cards, wherein the second plane is parallel to the first plane, wherein the first center stage card is directly optically coupled to the first input stage card and the second input stage card, and wherein the second center stage card is directly optically coupled to the first input stage card and the second input stage card; and
a plurality of output stage cards optically coupled to the plurality of center stage cards, wherein the plurality of output stage cards comprises a first output stage card and a second output stage card, wherein the first output stage card is orthogonal to the first center stage card and the second center stage card, wherein the second output stage card is orthogonal to the first center stage card and the second center stage card, wherein the second plane is at an edge of the plurality of output stage cards, wherein the second plane is orthogonal to the plurality of output cards, wherein the first output stage card is directly optically coupled to the first center stage card and the second center stage card, and wherein the second output stage card is directly optically coupled to the first center stage card and the second center stage card.

2. The photonic structure of claim 1, wherein a first optical path length is through the first input stage card, from the first input stage card to the first center stage card, through the first center stage card, from the first center stage card to the first output stage card, and through the first output stage cards, wherein a second optical path length is through the second input stage card, from the second input stage card to the second center stage card, through the second center stage card, from the second center stage card to the second output stage card, and through the second output stage cards, and wherein a difference between a length the first optical path and a length the second optical path length is less than one ns.

3. The photonic structure of claim 1, wherein a plurality of optical path lengths through input states of the plurality of input stages, center stages of the plurality of center stages, and output stages of the plurality of output stages is within one ns.

4. The photonic structure of claim 1, wherein an optical path through the first input stage card, from the first input stage card to the first center stage card, through the first center stage card, from the first center stage card to the first output stage card, and through the first output stage card has a propagation delay of less than 5 ns.

5. The photonic structure of claim 1, wherein the first center stage card comprises a first photonic module and a first electrical module on a first surface, wherein the second center stage card comprises a second photonic module and a second electrical module on a second surface, wherein the first surface is parallel to the second surface, wherein the first photonic module is directly over the second photonic module, and wherein the first electrical module is not directly over the second electrical module.

6. The photonic structure of claim 1, wherein the first input stage card comprises a first photonic module and a first electrical module on a first surface, wherein the second input stage card comprises a second photonic module and a second electrical module on a second surface, wherein the first surface is parallel to the second surface, wherein the first photonic module is directly over the second photonic module, and wherein the first electrical module is not directly over the second electrical module.

7. The photonic structure of claim 1, wherein the first output stage card comprises a first photonic module and a first electrical module on a first surface, wherein the second output stage card comprises a second photonic module and a second electrical module on a second surface, wherein the first surface is parallel to the second surface, wherein the first photonic module is directly over the second photonic module, and wherein the first electrical module is not directly over the second electrical module.

8. The photonic structure of claim 1, wherein the first center stage card of the plurality of center stage cards comprises:
a first non-contact optical connector directly coupled to the first input stage card; and
a second non-contact optical connector directly coupled to the first output stage card.

9. The photonic structure of claim 1, wherein the first center stage card comprises:
a strength plate;
a photonic module disposed on the strength plate; and
an optical module disposed on the strength plate.

10. The photonic structure of claim 1, further comprising an orthogonal mapper card directly optically coupled to the plurality of input cards and the plurality of output cards.

11. The photonic structure of claim 1, further comprising:
a first mid-plane electrically coupled to the plurality of input stage cards and the plurality of center stage cards; and
a second mid-plane electrically coupled to the plurality of output stage cards and the plurality of center stage cards.

12. The photonic structure of claim 11, further comprising a mid-plane interconnect coupled between the first mid-plane and the second mid-plane.

13. The photonic structure of claim 12, wherein the first mid-plan comprises a plurality of retractable multi-pin electrical connectors coupled to the plurality of center stage cards.

14. The photonic structure of claim 13, wherein the first mid-plane comprises an aperture, wherein a plurality of non-contact optical connections is between the plurality of input stage cards and the plurality of center stage cards are in the aperture.

15. The photonic structure of claim 11, wherein the plurality of input stage cards comprise a first switching stage, wherein the plurality of center stage cards comprise a second switching stage, and wherein the plurality of output stage cards comprise a third switching stage.

16. The photonic structure of claim 1, wherein the plurality of center stage cards are optically coupled to the plurality of input stage cards by a first plurality of two part non-contact expanded beam optical connectors, and wherein the plurality of center stage cards are optically coupled to the plurality of output stage cards by a second plurality of two part expanded beam non-contact optical connectors, and wherein first center stage card comprises a retractable electrical connector.

17. The photonic structure of claim 1, further comprising a first registration plate mechanically coupled between the plurality of input stage cards and the plurality of center stage cards and a second registration plate mechanically coupled between the plurality of center stage cards and the plurality of output stage cards.

18. An optical connection system comprising:
a first array of holes on a first side of a registration plate;
an array of grooves having a plurality of end stops on a second side of the registration plate;
a first plurality of graded refractive index (GRIN) lenses inserted into the first array of holes, wherein the first plurality of GRIN lenses comprises a first GRIN lens in a first hole of the first array of holes; and
a second plurality of GRIN lenses inserted in grooves of the array of grooves, wherein the first side of the registration plate is opposite the second side of the registration plate, wherein the second plurality of GRIN lenses comprises a second GRIN lens in a first groove of the array of grooves opposite the first GRIN lens, and wherein the first GRIN lens is optically coupled to the second GRIN lens by an air gap in the first hole.

19. The optical connection system of claim 18 wherein the first GRIN lens has a first diameter, wherein the second GRIN lens has a second diameter, and wherein the first diameter is smaller than the second diameter, and wherein the first lens is configured to propagate light to the second lens.

20. The optical connection system of claim 18, wherein the second plurality of GRIN lenses is configured to slide in along the array of grooves.

21. A registration plate comprising:
a row of holes;
a groove configured to receive a card along the row of holes, wherein the card comprises a row of non-contact optical connectors, and wherein the groove is configured to align the row of non-contact optical connectors with the row of holes; and
an end stop at an end of the groove, wherein the end stop is configured to align the row of non-contact optical connectors with the row of holes.

22. The registration plate of claim 21, further comprising a plurality of registration details above the row of holes.

23. A device comprising:
an optical macromodule;
a plurality of flexible waveguide extensions having a surface; and
a plurality of graded refractive index (GRIN) lenses, wherein the plurality of flexible waveguide extensions are optically coupled between the optical macromodule and the plurality of GRIN lenses.

24. The device of claim 23, further comprising:
an electrical module electrically coupled to the optical macromodule; and
a retractable electrical connector electrically coupled to the electrical module.

25. The device of claim 23, wherein the plurality of flexible waveguide comprises optical connectors, wherein the plurality of flexible waveguides is bowed in orthogonal to the surface and parallel to the optical connector.
